(19) United States
(12) Patent Application Publication
(10) Pub. No.: US 2025/0250383 A1
(43) Pub. Date: Aug. 7, 2025

(54) RESIN COMPOSITION, ADHESIVE MEMBER, AND DISPLAY DEVICE INCLUDING THE ADHESIVE MEMBER

(71) Applicant: Samsung Display Co., LTD., Yongin-si (KR)

(72) Inventor: Naoto INOUE, Yokohama (JP)

(21) Appl. No.: 19/013,674

(22) Filed: Jan. 8, 2025

(30) Foreign Application Priority Data
Feb. 7, 2024 (KR) 10-2024-0018632

(51) Int. Cl. C08F 283/00; C08F 2/50; C08K 5/3475; C09J 4/06; C09J 5/00; C09J 7/30; C09J 151/08

(52) U.S. Cl. CPC C08F 283/008; C08F 2/50; C08K 5/3475; C09J 4/06; C09J 5/00; C09J 7/30; C09J 151/08; C09J 2301/30; C09J 2301/416; C09J 2451/00

(57) ABSTRACT

A resin composition includes at least one first monomer containing one or two polymerizable unsaturated groups per monomer unit, at least one sub polymer having a weight average molecular weight in a range of about 5,000 to about 40,000 and derived from a second monomer containing two or more polymerizable unsaturated groups per monomer unit, a benzotriazole-based UV absorber, a diprenyl glycerin ether, and at least one photoinitiator containing a bisacylphosphine oxide group.

This application claims priority to Korean Patent Application No. 10-2024-0018632, filed on Feb. 7, 2024, and all the benefits accruing therefrom under 35 U.S.C. § 119, the content of which in its entirety is herein incorporated by reference.

### BACKGROUND

### (1) Field

Embodiments of the disclosure herein relate to a resin composition, an adhesive member formed using the resin composition, and a display device including the adhesive member.

### (2) Description of the Related Art

Various types of display devices are widely used as multimedia devices such as television sets, mobile phones, tablet computers, navigation systems, and game consoles. The display devices include multiple components forming the display devices, and adhesive members are disposed between the components.

### SUMMARY

In display devices, resin compositions may be used to form adhesive members therein, and the adhesive members included in the display devices are desired to stably bond the components of the display devices and exhibit no degradation in display quality in consideration of the usage environment for users.

Embodiments of the disclosure provide a resin composition exhibiting high reliability after curing, an adhesive member formed using the resin composition, and a display device including the adhesive member.

An embodiment of the invention provides a resin composition including at least one first monomer containing one or two polymerizable unsaturated groups per monomer unit, at least one sub polymer having a weight average molecular weight in a range of about 5,000 to about 40,000 and derived from a second monomer containing two or more polymerizable unsaturated groups per monomer unit, a benzotriazole-based ultraviolet (UV) absorber, a diprenyl glycerin ether, and at least one photoinitiator containing a bisacylphosphine oxide group.

In an embodiment, after photocuring, the resin composition has a thickness in a range of about 190 micrometers (μm) to about 210 μm, the resin composition may have a transmittance of greater than about 0% and less than or equal to about 5% for light in a wavelength range of about 405 nanometers (nm) or less.

In an embodiment, after photocuring, the resin composition has a thickness in a range of about 40 μm to about 60 μm, the resin composition may have a transmittance of greater than about 0% and less than or equal to about 15% for light in a wavelength range of about 405 nm or less.

In an embodiment, a content of the benzotriazole-based UV absorber may be in a range of about 0.5 weight percent (wt %) to about 2 wt % with respect to a total content of the resin composition.

In an embodiment, a content of the diprenyl glycerin ether may be in a range of about 0.1 wt % to about 1 wt % with respect to the total content of the resin composition.

In an embodiment, the first monomer may include a (meth)acrylate monomer.

In an embodiment, the first monomer may include a first sub-monomer containing one polymerizable unsaturated group per monomer unit and a second sub-monomer containing two polymerizable unsaturated groups per monomer unit.

In an embodiment, the first monomer may include at least one selected from 2-ethylhexyl acrylate (2-EHA), 4-hydroxybutyl acrylate (4-HBA-LT), 2-ethylhexyl-diglycol acrylate (EHDG-AT), tetrahydrofurfuryl acrylate (THF-A), isobornyl acrylate (IBXA), isodecyl acrylate (IDAA), and 1,9-nonanediol diacrylate (NDDA).

In an embodiment, the sub polymer may include a urethane (meth)acrylate oligomer.

In an embodiment, the photoinitiator may include bis(2,4,6-trimethylbenzoyl)phenyl phosphine oxide.

In an embodiment, the resin composition may be providable through inkjet printing or dispensing.

In an embodiment of the invention, an adhesive member includes a polymer derived from a resin composition, where the resin composition includes at least one first monomer containing one or two polymerizable unsaturated groups per monomer unit, at least one sub polymer having a weight average molecular weight in a range of about 5,000 to about 40,000 and derived from a second monomer containing two or more polymerizable unsaturated groups per monomer unit, a benzotriazole-based UV absorber, a diprenyl glycerin ether, and at least one photoinitiator containing a bisacylphosphine oxide group.

In an embodiment, when the adhesive member has a thickness in a range of about 190 μm to about 210 μm, the adhesive member may have a transmittance of greater than about 0% and less than or equal to about 5% for light in a wavelength range of about 405 nm or less.

In an embodiment, when the adhesive member has a thickness in a range of about 40 μm to about 60 μm, the adhesive member may have a transmittance of greater than about 0% and less than or equal to about 15% for light in a wavelength range of about 405 nm or less.

In an embodiment, the adhesive member may have a thickness of in a range of about 30 μm to about 300 μm.

In an embodiment, a content of the benzotriazole-based UV absorber may be in a range of about 0.5 wt % to about 2 wt % with respect to a total content of the resin composition.

In an embodiment, a content of the diprenyl glycerin ether may be in a range of about 0.1 wt % to about 1 wt % with respect to the total content of the resin composition.

In an embodiment, the first monomer may include a first sub-monomer containing one polymerizable unsaturated group per monomer unit and a second sub-monomer containing two polymerizable unsaturated groups per monomer unit.

In an embodiment, the first monomer may include at least one selected from 2-ethylhexyl acrylate (2-EHA), 4-hydroxybutyl acrylate (4-HBA-LT), 2-ethylhexyl-diglycol acrylate (EHDG-AT), tetrahydrofurfuryl acrylate (THF-A), isobornyl acrylate (IBXA), isodecyl acrylate (IDAA), and 1,9-nonanediol diacrylate (NDDA).

In an embodiment, the sub polymer may include a urethane (meth)acrylate oligomer.

In an embodiment, the photoinitiator may include bis(2,4,6-trimethylbenzoyl)phenyl phosphine oxide.

In an embodiment of the invention, a display device includes a display panel, a window disposed on the display panel, and an adhesive member disposed between the display panel and the window and including a polymer derived from a resin composition, where the resin composition including at least one first monomer containing one or two polymerizable unsaturated groups per monomer unit, a least one sub polymer having a weight average molecular weight in a range of about 5,000 to about 40,000 and derived from a second monomer containing two or more polymerizable unsaturated groups per monomer unit, a benzotriazole-based UV absorber, a diprenyl glycerin ether, and at least one photoinitiator containing a bisacylphosphine oxide group.

In an embodiment, the adhesive member has a thickness in a range of about 190 μm to about 210 μm, the adhesive member may have a transmittance of greater than about 0% and less than or equal to about 5% for light in a wavelength range of about 405 nm or less.

In an embodiment, the adhesive member has a thickness in a range of about 40 μm to about 60 μm, the adhesive member may have a transmittance of greater than about 0% and less than or equal to about 15% for light in a wavelength range of about 405 nm or less.

In an embodiment, the adhesive member may have a thickness in a range of about 30 μm to about 300 μm.

In an embodiment, a content of the benzotriazole-based UV absorber may be in a range of about 0.5 wt % to about 2 wt % with respect to a total content of the resin composition, and a content of the diprenyl glycerin ether may be in a range of about 0.1 wt % to about 1 wt % with respect to the total content of the resin composition.

In an embodiment, the first monomer may include a first sub-monomer containing one polymerizable unsaturated group per monomer unit and a second sub-monomer containing two polymerizable unsaturated groups per monomer unit.

In an embodiment, the first monomer may include at least one selected from 2-ethylhexyl acrylate (2-EHA), 4-hydroxybutyl acrylate (4-HBA-LT), 2-ethylhexyl-diglycol acrylate (EHDG-AT), tetrahydrofurfuryl acrylate (THF-A), isobornyl acrylate (IBXA), isodecyl acrylate (IDAA), and 1,9-nonanediol diacrylate (NDDA).

In an embodiment, the sub polymer may include a urethane (meth)acrylate oligomer.

In an embodiment, the photoinitiator may include bis(2,4,6-trimethylbenzoyl)phenyl phosphine oxide.

In an embodiment, the display device may further include a light control layer disposed between the adhesive member and the window, and an optical adhesive layer disposed between the light control layer and the window, where the optical adhesive layer may include a polymer derived from the resin composition.

In an embodiment, the display device may further include an input sensing part disposed between the display panel and the window, where the adhesive member may be disposed between the display panel and the input sensing part or between the input sensing unit and the window.

### BRIEF DESCRIPTION OF THE DRAWINGS

The above and other features of embodiments of the invention will become more apparent by describing in further detail embodiments thereof with reference to the accompanying drawings, in which:

FIG. 1 is a perspective view showing a display device according to an embodiment;

FIG. 2 is an exploded perspective view showing a display device according to an embodiment;

FIG. 3 is a cross-sectional view showing a portion corresponding to line I-I′ of FIG. 1;

FIG. 4 is a cross-sectional view showing a portion of a display device according to an embodiment;

FIG. 5A is a view schematically showing a method for manufacturing an adhesive member according to an embodiment;

FIG. 5B is a view schematically showing a method for manufacturing an adhesive member according to an embodiment;

FIG. 5C is a view schematically showing a method for manufacturing an adhesive member according to an embodiment;

FIG. 5D is a view schematically showing a method for manufacturing an adhesive member according to an embodiment;

FIG. 6A is a view schematically showing a method for manufacturing an adhesive member according to an embodiment;

FIG. 6B is a view schematically showing a method for manufacturing an adhesive member according to an embodiment;

FIG. 6C is a view schematically showing a method for manufacturing an adhesive member according to an embodiment;

FIG. 7 is a cross-sectional view showing a display device according to an embodiment;

FIG. 8 is a cross-sectional view showing a display device according to an embodiment; and

FIG. 9 is a view showing a vehicle in which a display device according to an embodiment is disposed.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element (or a region, a layer, a portion, or the like) is referred to as “being on”, “connected to” or “coupled to” another element, it may be directly disposed on, connected or coupled to the other element, or intervening elements may be disposed therebetween.

Like reference numerals refer to like elements. In addition, in the drawings, the thickness, the ratio, and the dimensions of elements are exaggerated for an effective description of technical contents.

It will be understood that, although the terms first, second, etc. may be used herein to describe various elements, these elements should not be limited by these terms. These terms are only used to distinguish one element from another element. For example, a first element may be referred to as a second element, and similarly, a second element may be referred to as a first element without departing from the teachings of the disclosure.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which the disclosure pertains. It is also to be understood that terms defined in commonly used dictionaries should be interpreted as having meanings consistent with the meanings in the context of the related art, and are expressly defined herein unless they are interpreted in an ideal or overly formal sense. Also, terms, such as those defined in commonly used dictionaries, should be interpreted as having a meaning that is consistent with their meaning in the context of the relevant art and should not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, an adhesive member according to an embodiment of the invention and a display device including the adhesive member will be described with reference to the accompanying drawings.

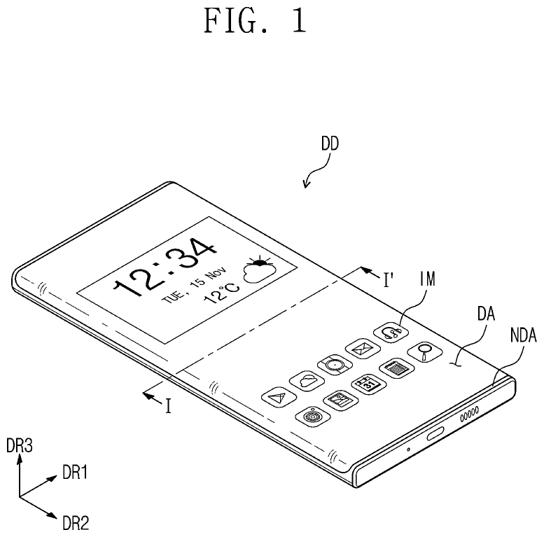

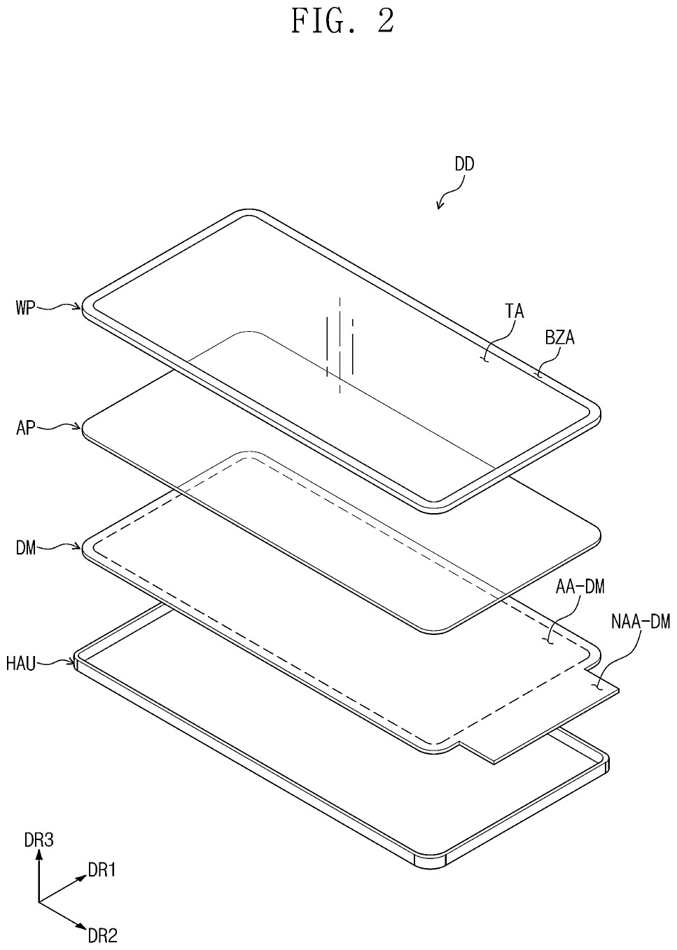

FIG. 1 is a perspective view showing a display device according to an embodiment. FIG. 2 is an exploded perspective view of a display device according to an embodiment.

An embodiment of a display device DD shown in FIG. 1 may be a device activated in response to electrical signals. For example, the display device DD may be personal computers, laptop computers, personal digital terminals, game consoles, portable electronic devices, television sets, monitors, outdoor billboards, car navigation systems, or wearable devices, but is not limited thereto. In FIG. 1, as an example, an embodiment where the display device DD is a mobile phone is shown.

The display device DD according to an embodiment may display an image IM through a display region DA. The display region DA may include a plane defined by a first directional axis DR1 and a second directional axis DR2. The display region DA may further include a curved surface bent from one side of the plane defined by the first directional axis DR1 and the second directional axis DR2. The display device DD according to an embodiment, as shown in FIG. 1, may include two curved surfaces each bent from both opposing sides of the plane defined by the first directional axis DR1 and the second directional axis DR2. However, the shape of the display region DA is not limited thereto. In another embodiment, for example, the display region DA may include only the plane defined by the first directional axis DR1 and the second directional axis DR2, and the display region DA may further include curved surfaces each bent from at least two sides of the plane defined by the first directional axis DR1 and the second directional axis DR2 (e.g., four curved surfaces each bent from four sides of the plane).

The display device DD according to an embodiment may be flexible. The term “flexible” indicates a property of being bendable, and may include all from a structure being completely foldable to a structure being bendable up to several nanometers. In an embodiment, for example, the display device DD may be a foldable display device. In another embodiment, the display device DD may be rigid.

A non-display region NDA may be a region adjacent to the display region DA. In an embodiment, the non-display region NDA may surround the display region DA. Accordingly, the shape of the display region DA may be defined substantially by the non-display region NDA. In another embodiment, for example, the non-display region NDA may be disposed adjacent to only one side of the display region DA, or may not be provided. The display region DA may be provided in various shapes and is not limited to any one embodiment.

FIG. 1 and the following drawings show first to third directional axes DR1 to DR3, and directions indicated by the first to third directional axes DR1, DR2, and DR3 described herein are relative concepts, and may thus be changed to other directions. In addition, the directions indicated by the first to third directional axes DR1, DR2, and DR3 may be described as first to third directions, and the same reference numerals may be used. The first directional axis DR1 and the second directional axis DR2 herein may be perpendicular to each other, and the third directional axis DR3 may be a normal direction with respect to a plane defined by the first directional axis DR1 and the second directional axis DR2.

A thickness direction of the display device DD may be parallel to the third directional axis DR3 which is a normal direction with respect to the plane defined by the first directional axis DR1 and the second directional axis DR2. As described herein, a front surface (or an upper surface, upper portion surface, upper side) and a rear surface (or a lower surface, lower portion surface, lower side) of members constituting the display device DD may be defined with respect to the third directional axis DR3. In addition, as described herein, a direction in which the third directional axis DR3 extends is parallel to the thickness direction, and the front surface (or an upper surface, upper portion surface, upper side) indicates a surface (or direction) adjacent to a surface on which the image IM is displayed, and the rear surface (or a lower surface, lower portion surface, lower side) indicates a surface (or direction) spaced apart from a surface on which the image IM is displayed. Herein, the term ‘plane’ refers to a plane parallel to the plane defined by the first directional axis DR1 and the second directional axis DR2, and the term ‘cross-section’ refers to a plane perpendicular to the plane defined by the first directional axis DR1 and the second directional axis DR2 and parallel to the thickness direction or the third directional axis DR3.

Referring to FIG. 2, an embodiment of the display device DD may include a display module DM, a window WP disposed on the display module DM, and an adhesive member AP disposed between the display module DM and the window WP. In an embodiment, the display device DD may further include a housing HAU accommodating the display module DM.

In an embodiment of the display device DD, as shown in FIGS. 1 and 2, the window WP and the housing HAU may be bonded together to form an outer portion of the display device DD. The housing HAU may be disposed below the display module DM. The housing HAU may include a material having a relatively higher rigidity. In an embodiment, for example, the housing HAU may include a plurality of frames and/or plates including or formed of glass, plastic, or metal. The housing HAU may provide a predetermined place for accommodation. The display module DM may be accommodated in the accommodation place to be protected from external shocks.

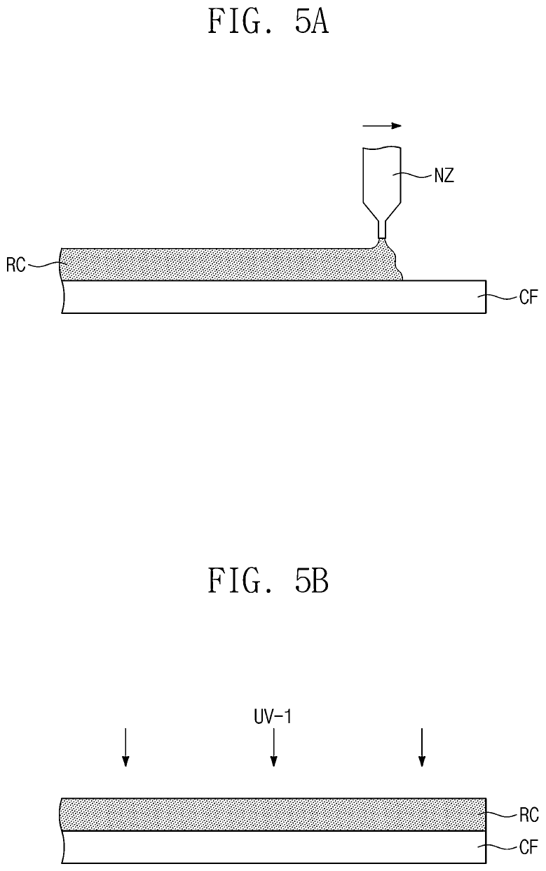

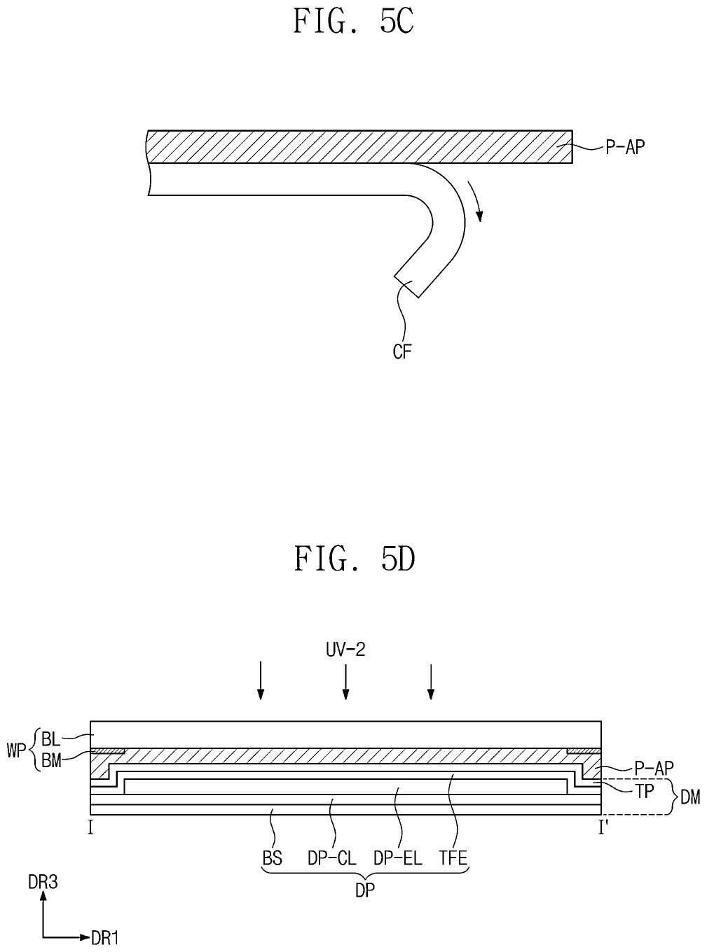

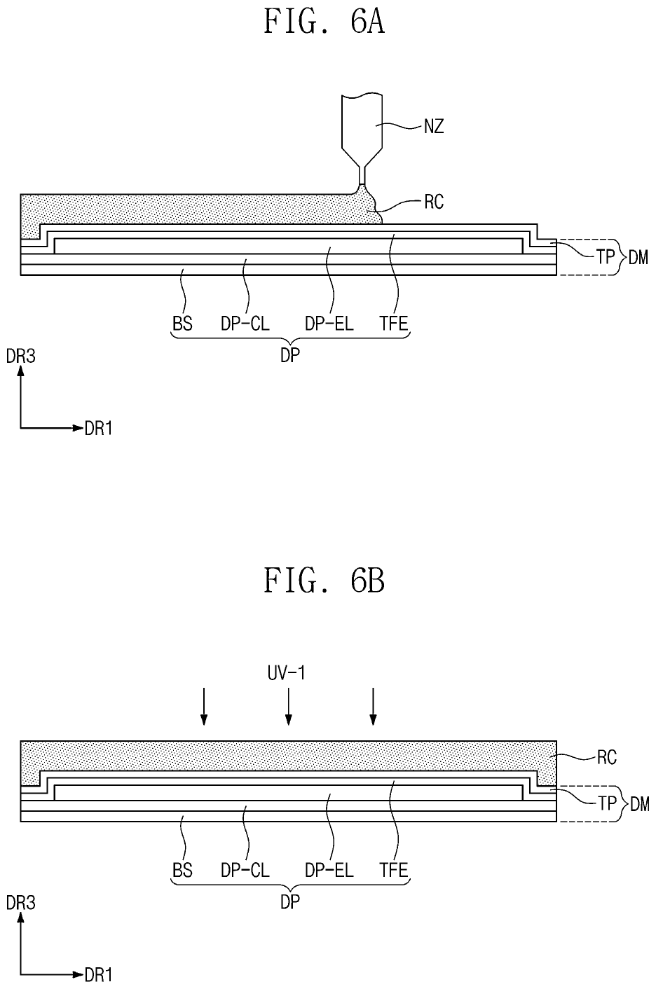

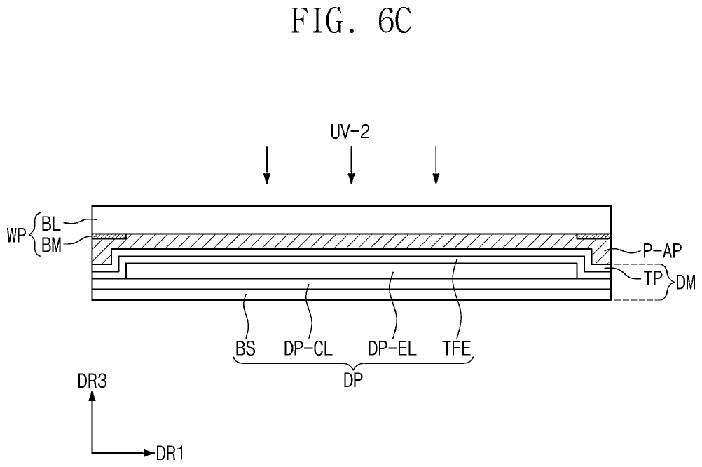

In an embodiment, the adhesive member AP may include a polymer derived or formed from a resin composition RC (FIGS. 5A and 6A). The adhesive member AP may be formed by photocuring the resin composition RC (FIGS. 5A and 6A). The display module DM and the window WP may be bonded to each other through the adhesive member AP. The adhesive member AP is formed from or using the resin composition RC (FIGS. 5A and 6A) containing an ultraviolet (UV) absorber and may thus effectively prevent damage from external light (e.g., UV light) to the display module DM. In an embodiment, the adhesive member AP may effectively prevent damage to the display module DM and also exhibit high adhesive strength. In an embodiment, the display device DD including the adhesive member AP may have improved display life and display quality, and may exhibit high reliability.

The window WP may include a transmission region TA and a bezel region BZA. The transmission region TA may overlap at least a portion of the active region AA-DM of the display module DM. The transmission region TA may be an optically transparent region. The image IM (FIG. 1) may be provided to users through the transmission region TA.

The bezel region BZA may be a region having a relatively lower light transmittance than the transmission region TA. The bezel region BZA may define a shape of the transmission region TA. The bezel region BZA may be adjacent to the transmission region TA and may surround the transmission region TA.

The bezel region BZA may have a predetermined color. The bezel region BZA covers the peripheral region NAA-DM of the display module DM, and may thus effectively prevent the peripheral region NAA-DM from being viewed from the outside. However, the embodiment of the invention is not limited to what is shown, and the bezel region BZA may be disposed adjacent to only one side of the transmission region TA, and at least a portion thereof may not be provided.

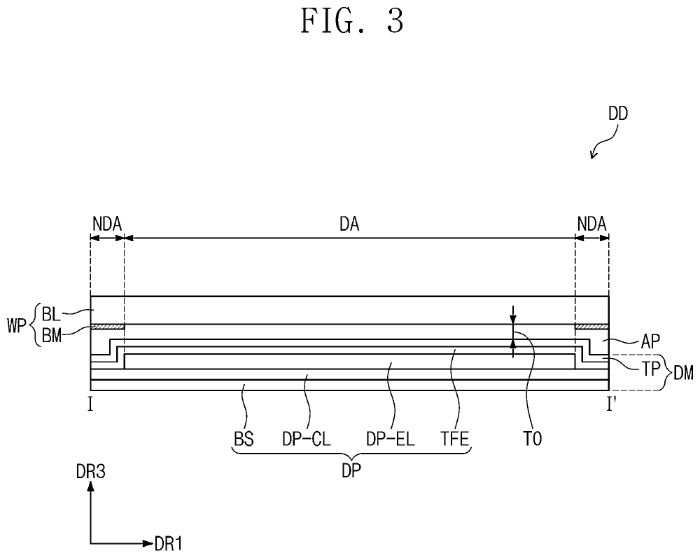

FIG. 3 is a cross-sectional view showing a portion corresponding to line I-I′ of FIG. 1. Particularly, FIG. 3 is a cross-sectional view showing the display module DM, the adhesive member AP, and the window WP of FIG. 2. FIG. 3 may be a cross-sectional view showing a display device DD according to an embodiment.

Referring to FIG. 3, an embodiment of the display module DM may include a display panel DP and an input sensing part TP disposed on the display panel DP. The display panel DP may be configured to substantially generate images. The display panel DP may include a base substrate BS, a circuit layer DP-CL disposed on the base substrate BS, and a display element layer DP-EL disposed on the circuit layer DP-CL, and an encapsulation layer TFE covering the display element layer DP-EL. The adhesive member AP may be disposed between the display panel DP and the window WP.

It would be understood that the components of the display panel DP shown in FIG. 3 and the like are an example and the components of the display panel DP are not limited thereto. In an embodiment, for example, the display panel DP may include a liquid crystal display element, and in such an embodiment, the encapsulation layer TFE may not be provided.

The base substrate BS may provide a base surface on which the circuit layer DP-CL is disposed. The base substrate BS may be a flexible substrate that is bendable, foldable, rollable, or the like. The base substrate BS may be a glass substrate, a metal substrate, or a polymer substrate. However, the embodiment of the invention is not limited thereto, and the base substrate BS may be an inorganic layer, an organic layer, or a composite material layer.

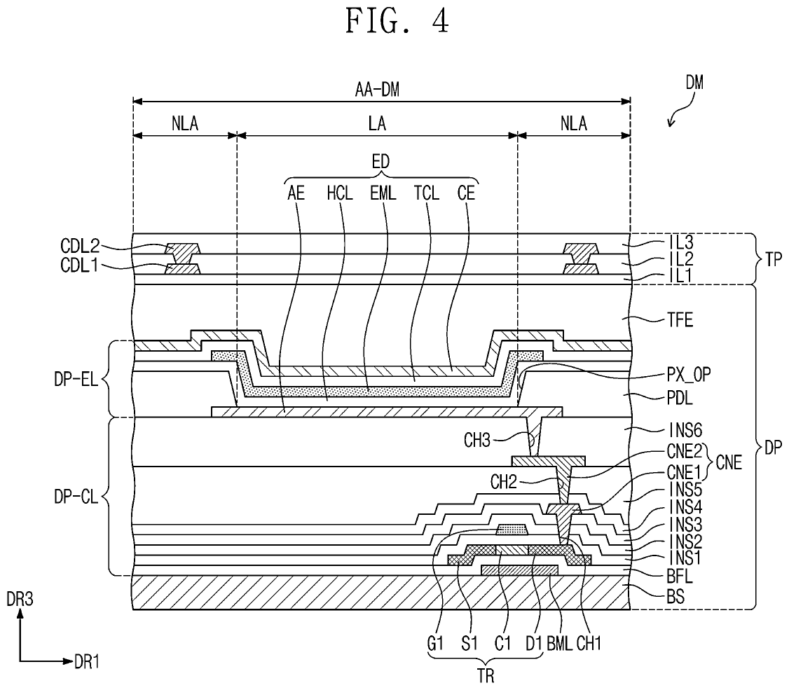

The circuit layer DP-CL may include an insulating layer, a semiconductor pattern, a conductive pattern, a signal line, and the like. In an embodiment, for example, the circuit layer DP-CL may include a switching transistor and a driving transistor for driving a light emitting element ED (FIG. 4) of the display element layer DP-EL.

The display element layer DP-EL may include a light emitting element (FIG. 4) that emits light. In an embodiment, for example, the light emitting element (FIG. 4) may include organic light emitting materials, inorganic light emitting materials, organic-inorganic light emitting materials, quantum dots, or quantum rods. The light emitting element (FIG. 4) may include micro light emitting diodes (LEDs) or nano LEDs.

The encapsulation layer TFE may be disposed on the display element layer DP-EL. The encapsulation layer TFE may serve to protect the light emitting element layer DP-EL from moisture, oxygen, and/or foreign substances such as dust particles. The encapsulation layer TFE may include at least one inorganic layer. In an embodiment, for example, the encapsulation layer TFE may include an inorganic layer, an organic layer, and an inorganic layer, which are sequentially stacked.

The input sensing part TP may be disposed on the display panel DP. In an embodiment, for example, the input sensing part TP may be directly disposed on the encapsulation layer TFE of the display panel DP. Alternatively, an adhesive layer may be disposed between the input sensing part TP and the display panel DP.

Herein, when a component is directly disposed/provided on another component, it indicates that a third component is not disposed/provided between one component and another component. That is, when a component is ‘directly disposed/provided’ on another component, it indicates that a component is in “contact” with another component.

The input sensing part TP may sense external inputs to convert the inputs into predetermined input signals, and provide the input signals to the display panel DP. For example, in the display device DD according to an embodiment, the input sensing part TP may be a touch sensing portion detecting a touch. The input sensing part TP may recognize a user's direct touch, a user's indirect touch, a direct touch of an object, or an indirect touch of an object.

The input sensing part TP may sense at least any one of a location of a touch or strength (pressure) of a touch applied from the outside. In an embodiment, the input sensing part TP may have various structures or be formed of various materials, and is not limited to any one embodiment. In an embodiment, for example, the input sensing part TP may detect external inputs using a capacitive method. The display panel DP may receive the input signals from the input sensing part TP and generate images corresponding to the input signals.

The window WP may include a base layer BL and a printing layer BM. Although not shown, the window WP may further include at least one functional layer (not shown) provided on the base layer BL. In an embodiment, for example, the functional layer (not shown) may be a hard coating layer, an anti-fingerprint coating layer, and the like, but the embodiment of the invention is not limited thereto.

The base layer BL may be a glass substrate. Alternatively, the base layer BL may be a plastic substrate. In an embodiment, for example, the base layer BL may include or be formed of polyimide, polyacrylate, polymethylmethacrylate, polycarbonate, polyethylenenaphthalate, polyvinylidene chloride, polyvinylidene difluoride, polystyrene, ethylene vinylalcohol copolymer, or a combination thereof.

The printing layer BM may be disposed on one surface of the base layer BL. The printing layer BM may be provided on a lower surface of the base layer BL adjacent to the display module DM. The printing layer BM may be disposed on an edge region of the base layer BL. The printing layer BM may be an ink printing layer. In addition, the printing layer BM may be a layer formed by including a pigment or dye. In the window WP, the bezel region BZA may be a portion in which the printed layer BM is provided.

The adhesive member AP may be disposed between the input sensing part TP and the window WP. The adhesive member AP may have a thickness T0 in a range of about 30 micrometers (μm) to about 300 μm. In an embodiment, for example, the adhesive member AP may have a thickness T0 in a range of about 50 μm to about 200 μm. The adhesive member AP having a thickness T0 in a range of about 30 μm to about 300 μm may stably bond members (e.g., display panel, window, and the like) forming the display device DD without an excessive increase in the thickness of the display device DD.

In an embodiment where the adhesive member AP has a thickness T0 in a range of about 40 μm to about 60 μm, the adhesive member may have a transmittance of greater than about 0% and of about 15% or less (i.e., less than or equal to about 15%) for light in the wavelength range of about 405 nanometers (nm) or less. In an embodiment where the adhesive member AP has a thickness T0 of about 50 μm, the adhesive member may have a transmittance of greater than about 0% and about 15% or less for light in the wavelength range of about 405 nm or less. In an embodiment, for example, where the adhesive member AP has a thickness T0 of about 50 μm, the adhesive member may have a transmittance in a range of about 1% to about 9% for light in the wavelength range of about 405 nm or less.

In an embodiment where the adhesive member AP has a thickness T0 in a range of about 190 μm to about 210 μm, the adhesive member may have a transmittance of greater than about 0% and about 5% or less (i.e., less than or equal to about 5%) for light in the wavelength range of about 405 nm or less. In an embodiment where the adhesive member AP has a thickness T0 of about 200 μm, the adhesive member may have a transmittance of greater than about 0% and about 5% or less for light in the wavelength range of about 405 nm or less. In an embodiment where the adhesive member AP has a thickness T0 of about 200 μm, the adhesive member may have a transmittance in a range of about 0.4% to about 4% for light in the wavelength range of about 405 nm or less.

Light in a wavelength range of about 405 nm or less includes UV, and includes light in a wavelength range that has a significant impact on degrading the properties of light emitting elements. Light in the wavelength range of greater than about 405 nm and about 800 nm or less may correspond to visible light. Herein, the transmittance for light in the wavelength range of about 405 nm or less indicates the transmittance measured after a light resistance test in accordance with a method of MIL-810G.

The adhesive member AP that satisfies the above-described transmittance range for light in the wavelength range of about 405 nm or less has a low UV transmittance, and of the adhesive member AP may effectively prevent components (e.g., light emitting elements) disposed therebelow from being degraded by UV. Light emitting elements containing organic materials are typically vulnerable to UV and degraded when exposed to UV. In addition, the adhesive member AP that satisfies the above-described transmittance range for light in the wavelength range of about 405 nm or less may have small changes in yellow index (YI) from exposure to external light such as UV. The usage environment of display devices includes exposure to external light such as UV, and an adhesive member having significant changes in yellow index from exposure to external light degrade display quality in the provision of images generated from a display module disposed below the adhesive member. The images generated from the display module passes through the adhesive member and is provided to users. In an embodiment, the adhesive member AP has small changes in yellow index such that the display device DD including the adhesive member AP may exhibit high reliability, and the display device DD including the adhesive member AP may exhibit high display quality and display lifetime.

For example, the adhesive member AP according to an embodiment may satisfy Inequality 1 below. However, this is presented as an example, and the embodiment of the invention is not limited thereto.

$${X}_{2} - {X}_{1} < 3 \qquad [ Inequality 1 ]$$

In Inequality 1, X₁ denotes a first coordinate, which is the CIE color coordinate b* measured using a spectrophotometer COH 7700 (NIPPON DENSHOKU INDUSTRIES Co., Ltd), and X₂ denotes a second coordinate, which is the CIE color coordinate b* measured using a spectrophotometer COH 7700 after a light resistance test in accordance with a method of MIL-810G. That is, Inequality 1 indicates that a difference (X₂−X₁) in CIE color coordinate b* values before and after the light resistance test is less than 3. The adhesive member AP in which the difference in CIE color coordinate b* values before and after the light resistance test is less than 3 is provided with small changes in color coordinate values, and may thus exhibit high reliability even when the time of exposure to UV accumulates in usage environment for users.

For example, the adhesive member AP according to an embodiment may satisfy Inequality 2 below. However, this is presented as an example, and the embodiment of the invention is not limited thereto.

$${Y}_{2} - {Y}_{1} < 5 \qquad [ Inequality 2 ]$$

In Inequality 2, Y₁ denotes a first yellow index, which is the yellow index measured using a spectrophotometer COH 7700, and Y₂ denotes a second yellow index, which is the yellow index measured using a spectrophotometer after a light resistance test in accordance with a method of MIL-810G. That is, Inequality 2 indicates that a difference (Y₂−Y₁) in yellow index values before and after the light resistance test is less than 5. The adhesive member AP in which the difference in yellow index values before and after the light resistance test is less than 5 is provided with small changes in yellow index, and may thus exhibit high reliability even when the time of exposure to UV accumulates in usage environment for users.

FIG. 4 is a cross-sectional view specifically showing the display module DM of FIG. 3. Components of the display module DM shown in FIG. 4 are presented as an example, and the embodiment of the invention is limited thereto.

In an embodiment, as shown in FIG. 4, the base substrate BS may include a single layer or multiple layers. In an embodiment, for example, the base substrate BS may include a first synthetic resin layer, a multi-or single-layered inorganic layer, and a second synthetic resin layer disposed on the multi-or single-layered inorganic layer. Each of the first synthetic resin layer and the second synthetic resin layer may include a polyimide-based resin. In addition, each of the first synthetic resin layer and the second synthetic resin layer may include at least one selected from an acryl-based resin, a methacryl-based resin, a polyisoprene-based resin, a vinyl-based resin, an epoxy-based resin, a urethane-based resin, a cellulose-based resin, a siloxane-based resin, a polyamide-based resin, and a perylene-based resin. Herein, a “˜˜based” resin may be considered as including a functional group of “˜˜”.

The display panel DP may include a transistor TR and a light emitting element ED. The transistor TR and the light emitting element ED may be disposed on the base substrate BS. Although one transistor TR is shown in FIG. 4 for convenience of illustration and description, an embodiment of the display panel DP may include a plurality of transistors and at least one capacitor for driving the light emitting element ED.

The circuit layer DP-CL may be disposed on the base substrate BS. The circuit layer DP-CL may include a shielding electrode BML, a transistor TR, a connection electrode CNE, and a plurality of insulating layers BFL and INS1 to INS6. The plurality of insulating layers BFL, and INS1 to INS6 may include a buffer layer BFL and first to sixth insulating layers INS1 to INS6. However, the stacked structure of the circuit layer DP-CL shown in FIG. 4 is presented as an example, and the stacked structure of the circuit layer DP-CL may change depending on components of the display panel DP and processes of the circuit layer DP-CL.

The shielding electrode BML may be disposed on the base substrate BS. The shielding electrode BML may overlap the transistor TR. The shielding electrode BML may protect the transistor TR by blocking light incident on the transistor TR from a lower portion of the display panel DP. The shielding electrode BML may include a conductive material. When a voltage is applied to the shielding electrode BML, threshold voltage of the transistor TR disposed on the shielding electrode BML may be maintained. However, the embodiment of the invention is not limited thereto, and the shielding electrode BML may be a floating electrode. The shielding electrode BML may not be provided.

The buffer layer BFL may be disposed on the base substrate BS to cover the shielding electrode BML. The buffer layer BFL may include an inorganic layer. The buffer layer BFL may improve the bonding force between the base substrate BS and a semiconductor pattern or a conductive pattern disposed on the buffer layer BFL.

The transistor TR may include a source S1, a channel C1, a drain D1, and a gate G1. The source S1, the channel C1, and the drain D of the transistor TR may be formed from or defined by the semiconductor pattern. The semiconductor pattern of the transistor TR may include polysilicon, amorphous silicon, or metal oxide, and may include any material as long as it has semiconductor properties, and is not particularly limited.

The semiconductor pattern may include a plurality of regions divided according to the level of conductivity. In the semiconductor pattern, a region doped with a dopant or reduced with metal oxide may have high conductivity and may substantially serve as a source electrode and a drain electrode of the transistor TR. The region having high conductivity in the semiconductor pattern may correspond to the source S1 and the drain D1 of the transistor TR. In the semiconductor pattern, a region undoped, doped at a low concentration, or non-reduced with metal oxide may have low conductivity and correspond to the channel C1 (or active) of the transistor TR.

The first insulating layer INS1 may cover the semiconductor pattern of the transistor TR and be disposed on the buffer layer BFL. The gate G1 of the transistor TR may be disposed on the first insulating layer INS1. When viewed on a plane or when viewed in the third direction DR3, the gate G1 may overlap the channel C1 of the transistor TR. The gate G1 may serve as a mask in the process of doping the semiconductor pattern of the transistor TR.

The second insulating layer INS2 may cover the gate G1 and be disposed on the first insulating layer INS1. The third insulating layer INS3 may be disposed on the second insulating layer INS2.

The connection electrode CNE may include a first connection electrode CNE1 and a second connection electrode CNE2 to electrically connect the transistor TR and the light emitting element ED. However, the components of the connection electrode CNE that electrically connect the transistor TR and the light emitting element ED is not limited to thereto, and one of the first and second connection electrodes CNE1 and CNE2 may be omitted or an additional connection electrode may be further included.

The first connection electrode CNE1 may be disposed on the third insulating layer INS3. The first connection electrode CNE1 may be connected to the drain D1 through a first contact hole CH1 defined through the first to third insulating layers INS1 to INS3. The fourth insulating layer INS4 may cover the first connection electrode CNE1 and be disposed on the third insulating layer INS3. The fifth insulating layer INS5 may be disposed on the fourth insulating layer INS4.

The second connection electrode CNE2 may be disposed on the fifth insulating layer INS5. The second connection electrode CNE2 may be connected to the first connection electrode CNE1 through a second contact hole CH2 defined through the fourth and fifth insulating layers INS4 and INS5. The sixth insulating layer INS6 may cover the second connection electrode CNE2 and be disposed on the fifth insulating layer INS5.

The first to sixth insulating layers INS1 to INS6 may each include an inorganic layer or an organic layer. In an embodiment, for example, the inorganic layer may include at least one selected from aluminum oxide, titanium oxide, silicon oxide, silicon oxynitride, zirconium oxide, and hafnium oxide. The organic layer may include at least one selected from an acryl-based resin, a methacryl-based resin, a polyisoprene-based resin, a vinyl-based resin, an epoxy-based resin, a urethane-based resin, a cellulose-based resin, a siloxane-based resin, a polyamide-based resin, and a perylene-based resin.

The display element layer DP-EL may include a pixel defining film PDL and a light emitting element ED. The light emitting element ED may include a first electrode AE, a hole control layer HCL, an emission layer EML, an electron control layer TCL, and a second electrode CE. The light emitting element ED may include at least one organic material. In an embodiment, for example, at least one selected from the hole control layer HCL, the emission layer EML, and the electron control layer TCL may include an organic material.

The first electrode AE may be disposed on the sixth insulating layer INS6. The first electrode AE may be connected to the second connection electrode CNE2 through a third contact hole CH3 defined through the sixth insulating layer INS6. The first electrode AE may be electrically connected to the drain D1 of the transistor TR through the first and second connection electrodes CNE1 and CNE2.

The first electrode AE may include or be formed of a metal material, a metal alloy or a conductive compound. The first electrode AE may be an anode or a cathode. However, the embodiment of the invention is not limited thereto. In addition, the first electrode AE may be a pixel electrode. In an embodiment, for example, the first electrode AE may be a transmissive electrode, a transflective electrode, or a reflective electrode. The first electrode AE may include at least one selected from Ag, Mg, Cu, Al, Pt, Pd, Au, Ni, Nd, Ir, Cr, Li, Ca, LiF, Mo, Ti, W, In, Sn, and Zn, two or more compounds selected therefrom, two or more mixtures selected therefrom, or an oxide thereof.

In an embodiment where the first electrode AE is the transmissive electrode, the first electrode AE may include a transparent metal oxide such as indium tin oxide (ITO), indium zinc oxide (IZO), zinc oxide (ZnO), and indium tin zinc oxide (ITZO). In an embodiment where the first electrode AE is the transflective electrode or the reflective electrode, the first electrode AE may include Ag, Mg, Cu, Al, Pt, Pd, Au, Ni, Nd, Ir, Cr, Li, Ca, LiF/Ca (a stack structure of LiF and Ca), LiF/Al (a stack structure of LiF and Al), Mo, Ti, W, a compound thereof, or a mixture thereof (e.g., a mixture of Ag and Mg). Alternatively, the first electrode AE may have a multilayer structure including a reflective film or a transflective film formed of the above-described materials, and a transparent conductive film formed of indium tin oxide (ITO), indium zinc oxide (IZO), zinc oxide (ZnO), indium tin zinc oxide (ITZO), and the like. In an embodiment, for example, the first electrode AE may have a three-layer structure of ITO/Ag/ITO, but is not limited thereto. In addition, the embodiment of the invention is not limited thereto, and the first electrode AE may include the above-described metal materials, a combination of two or more metal materials selected from the above-described metal materials, or oxides of the above-described metal materials.

The pixel defining film PDL may be disposed on the sixth insulating layer INS6. A light emitting opening PX_OP exposing a portion of the first electrode AE may be defined in the pixel defining film PDL. A portion of the first electrode AE exposed by the light emitting opening PX_OP may be defined as a light emitting region LA.

The active region AA-DM of the display module DM may include the light emitting region LA and a light blocking region NLA. A region in which the pixel defining film PDL is disposed may correspond to the light blocking region NLA. The light blocking region NLA may surround the light emitting region LA in the active region AA-DM.

The hole control layer HCL may be disposed on the first electrode AE and the pixel defining film PDL. The hole control layer HCL may be provided as a common layer overlapping the light emitting region LA and the light blocking region NLA. The hole control layer HCL may include at least one selected from a hole transport layer, a hole injection layer, and an electron blocking layer. The hole control layer HCL may include known hole injection materials and/or known hole transport materials.

The emission layer EML may be disposed on the hole control layer HCL. The emission layer EML may be disposed in a region corresponding to the light emitting opening PX_OP. Alternatively, the emission layer EML may be provided as a common layer. The emission layer EML may include an organic light emitting material and/or an inorganic light emitting material. In an embodiment, for example, the emission layer EML may emit color light of any one of red, green, and blue. In an embodiment, for example, the emission layer EML may emit blue light.

The electron control layer TCL may be disposed on the emission layer EML. The electron control layer TCL may be provided as a common layer overlapping the light emitting region LA and the light blocking region NLA. The electron control layer TCL may include at least one selected from an electron transport layer, an electron injection layer, and a hole blocking layer. The electron control layer TCL may include known electron injection materials and/or known electron transport materials.

The second electrode CE may be disposed on the electron control layer TCL. The second electrode CE may be provided as a common layer overlapping the light emitting region LA and the light blocking region NLA.

The second electrode CE may be a common electrode. The second electrode CE may be a cathode or an anode but the embodiment of the invention is not limited thereto. In an embodiment, for example, when the first electrode AE is an anode, the second electrode CE may be a cathode, and when the first electrode AE is a cathode, the second electrode CE may be an anode.

The second electrode CE may be a transmissive electrode, a transflective electrode, or a reflective electrode. In an embodiment where the second electrode CE is a transmissive electrode, the second electrode CE may include or be formed of a transparent metal oxide, for example, indium tin oxide (ITO), indium zinc oxide (IZO), zinc oxide (ZnO), indium tin zinc oxide (ITZO), and the like.

In an embodiment where the second electrode CE is a transflective electrode or a reflective electrode, the second electrode CE may include Ag, Mg, Cu, Al, Pt, Pd, Au, Ni, Nd, Ir, Cr, Li, Ca, LiF/Ca, LiF/Al, Mo, Ti, Yb, W, a compound thereof, or a mixture thereof (e.g., AgMg, AgYb, or MgYb). Alternatively, the second electrode CE may have a multilayer structure including a reflective film or a transflective film formed of the above-described materials, and a transparent conductive film formed of indium tin oxide (ITO), indium zinc oxide (IZO), zinc oxide (ZnO), indium tin zinc oxide (ITZO), etc. In an embodiment, for example, the second electrode CE may include the above-described metal materials, a combination of two or more metal materials selected from the above-described metal materials, or oxides of the above-described metal materials.

The encapsulation layer TFE may be disposed on the second electrode CE and may thus cover the light emitting element ED. The encapsulation layer TFE may include a plurality of thin films. In an embodiment, for example, the encapsulation layer TFE may include inorganic layers disposed on the second electrode CE and an organic layer disposed between the inorganic layers. The inorganic film may protect the light emitting element ED from moisture/oxygen, and the organic film may protect the light emitting element ED from foreign substances such as dust particles.

The input sensing part TP may include a first sensing insulating layer IL1, a second sensing insulating layer IL2, and a third sensing insulating layer IL3. The input sensing part TP may include at least one conductive layer disposed on the sensing insulating layers. The input sensing part TP may include a first conductive layer CDL1 and a second conductive layer CDL2.

The first sensing insulating layer IL1 may be disposed on the encapsulation layer TFE. The first sensing insulating layer IL1 may include at least one inorganic insulating layer. The first sensing insulating layer IL1 may be in contact with the encapsulation layer TFE. Alternatively, the first sensing insulating layer IL1 may be omitted, and the first conductive layer CDL1 may contact the encapsulation layer TFE.

The first conductive layer CDL1 may be disposed on the first sensing insulating layer IL1. The first conductive layer CDL1 may include a plurality of first conductive patterns. The plurality of first conductive patterns may be disposed on the first sensing insulating layer IL1. The second sensing insulating layer IL2 may be disposed on the first sensing insulating layer IL1 to cover at least a portion of the first conductive layer CDL1.

The second conductive layer CDL2 may be disposed on the second sensing insulating layer IL2. The second conductive layer CDL2 may include a plurality of second conductive patterns. The plurality of second conductive patterns may be disposed on the second sensing insulating layer IL2. The plurality of second conductive patterns may each be connected to the plurality of first conductive patterns through a contact hole formed in the second sensing insulating layer IL2.

The plurality of first conductive patterns of the first conductive layer CDL1 and the plurality of second conductive patterns of the second conductive layer CDL2 may each be disposed to correspond to the light blocking region NLA. The plurality of first conductive patterns of the first conductive layer CDL1 and the plurality of second conductive patterns of the second conductive layer CDL2 may each correspond to a mesh pattern.

The third sensing insulating layer IL3 may be disposed on the second sensing insulating layer IL2 and may cover the second conductive layer CDL2. The second sensing insulating layer IL2 and the third sensing insulating layer IL3 may each include an inorganic insulating layer or an organic insulating layer.

The first conductive layer CDL1 and the second conductive layer CDL2 each may have a single-layered structure or may have a multi-layered structure stacked along the third direction DR3. The single-layer conductive layers CDL1 and CDL2 may include a metal layer or a transparent conductive layer. The metal layer may include molybdenum, silver, titanium, copper, aluminum, or an alloy thereof. The transparent conductive layer may include a transparent conductive oxide such as indium tin oxide (ITO), indium zinc oxide (IZO), zinc oxide (ZnO), and indium zinc tin oxide (IZTO). In addition, the transparent conductive layer may include a conductive polymer such as PEDOT, metal nanowire, graphene, and the like.

The multi-layered conductive layers CDL1 and CDL2 may include metal layers. In an embodiment, for example, the metal layers may have a three-layer structure of titanium (Ti)/aluminum (Al)/titanium (Ti). The multi-layered conductive layers CDL1 and CDL2 may include at least one metal layer and at least one transparent conductive layer.

FIGS. 5A to 5D are views schematically showing a method for manufacturing an adhesive member AP using a resin composition RC according to an embodiment. In an embodiment, for example, the method for manufacturing an adhesive member AP may include providing a resin composition RC on a substrate CF, providing (or emitting) first light UV-1 to the resin composition RC to form a preliminary adhesive member P-AP, and providing second light UV-2 to the preliminary adhesive member P-AP to form an adhesive member AP. In an embodiment, the adhesive member AP may be formed through a polymerization reaction of materials included in the resin composition RC. In the description of an embodiment of a method for manufacturing an adhesive member AP using a resin composition RC with reference to FIG. 5A to 5D, any repetitive detailed description of the same or like elements as those described above with reference to FIGS. 1 to 4 will be omitted, and differences will be mainly described.

Referring to FIG. 5A, in an embodiment, the resin composition RC may be provided on the substrate CF. The resin composition RC may be provided on the substrate CF through a nozzle NZ. FIG. 5A shows that the resin composition RC is provided through the nozzle NZ, but the device for providing the resin composition RC is not limited to thereto. In an embodiment, for example, the substrate CF on which the resin composition RC is provided may include polyethylene terephthalate (PET). The substrate CF is a temporary substrate used to form the adhesive member AP (FIG. 3) using the resin composition RC, and may be used without limitation as long as it is easily detached after the resin composition RC is cured. One side of the substrate CF, on which the resin composition RC is provided, may be subjected to release treatment.

In an embodiment, the resin composition RC may be providable (i.e., have characteristics allowing the resin composition RC to be provided) through inkjet printing or dispensing. In an embodiment, for example, the resin composition RC may be a liquid resin composition RC that may be provided in a uniform amount and/or at a uniform rate through inkjet printing or dispensing.

In an embodiment, the resin composition RC may be a liquid resin composition that is cured or curable through active energy rays. The active energy rays include visible rays, UV rays, electron beams, plasma, and heat rays (infrared (IR) rays, and the like).

In an embodiment, the resin composition may include at least one first monomer containing one or two polymerizable unsaturated groups per monomer unit, at least one sub polymer having a weight average molecular weight in a range of about 5,000 to about 40,000 and derived from a second monomer containing two or more polymerizable unsaturated groups per monomer unit, a benzotriazole-based UV absorber, a diprenyl glycerin ether, and at least one photoinitiator containing a bisacylphosphine oxide group. Herein, the polymerizable unsaturated group indicates a group containing an unsaturated bond that may be involved in a polymerization reaction.

The first monomer of the resin composition RC may include a (meth)acrylate monomer. Herein, the (meth)acryloyl group indicates an acryloyl group or a methacryloyl group, and the (meth)acrylate indicates acrylate or methacrylate.

The first monomer may include a monomer having a weight average molecular weight in a range of about 100 to about 500. The first monomer may include at least one selected from a first sub-monomer containing one polymerizable unsaturated group per monomer unit and a second sub-monomer containing two polymerizable unsaturated groups per monomer unit. In an embodiment, one polymerizable unsaturated group included in the first sub-monomer may be the same as one of two polymerizable unsaturated groups included in the second sub-monomer. Alternatively, one polymerizable unsaturated group included in the first sub-monomer may be different from two polymerizable unsaturated groups included in the second sub-monomer.

The first monomer may include at least one selected from 2-ethylhexyl acrylate (2-EHA), 4-hydroxybutyl acrylate (4-HBA-LT), 2-ethylhexyl-diglycol acrylate (EHDG-AT), tetrahydrofurfuryl acrylate (THF-A), isobornyl acrylate (IBXA), isodecyl acrylate (IDAA), and 1,9-nonanediol diacrylate (NDDA).

In an embodiment, for example, the first monomer may include a plurality of first sub-monomers. The first sub-monomers may include 2-ethylhexyl acrylate (2-EHA), 4-hydroxybutyl acrylate (4-HBA-LT), 2-ethylhexyl-diglycol acrylate (EHDG-AT), and tetrahydrofurfuryl acrylate (THF-A). Alternatively, the first monomer may include a plurality of first sub-monomers and a single second sub-monomer. The first sub-monomers may include 4-hydroxybutyl acrylate (4-HBA-LT), tetrahydrofurfuryl acrylate (THF-A), isobornyl acrylate (IBXA), and isodecyl acrylate (IDAA), and the second sub-monomer may include 1,9-nonanediol diacrylate (NDDA). However, this is only presented as an example, and the first sub-monomers and the second sub-monomer are not limited thereto.

The resin composition RC may include at least one sub polymer having a weight average molecular weight in a range of about 5,000 to about 40,000. At least one sub polymer having a weight average molecular weight in a range of about 5000 to about 40000 may contain two or more polymerizable unsaturated groups. At least one sub polymer having a weight average molecular weight in a range of about 5000 to about 40000 may be derived from a second monomer containing two or more polymerizable unsaturated groups per monomer unit. At least one sub polymer having a weight average molecular weight in a range of about 5000 to about 40000 may contain two or more polymerizable unsaturated groups.

The second monomer may be the same as or different from the first monomer. The sub polymer having a weight average molecular weight in a range of about 5,000 to about 40,000 is included in the resin composition RC with a relatively high degree of polymerization and maintains the high degree of polymerization even after photo curing, thereby forming an adhesive member AP having high adhesion.

In the resin composition RC, at least one sub polymer having a weight average molecular weight in a range of about 5000 to about 40000 may include a urethane (meth)acrylate oligomer. For example, in the resin composition RC, at least one sub polymer may have a weight average molecular weight in a range of about 10,000 to about 38,000. In the resin composition RC, at least one sub polymer may be derived from the second monomer containing two or more polymerizable unsaturated groups per monomer unit, and may have a weight average molecular weight of 10000, 13000, 35000, or 38000.

For example, a content of the sub polymer having a weight average molecular weight in a range of about 5000 to about 40000 and derived from the second monomer containing two or more polymerizable unsaturated groups per monomer unit may be in a range of about 3 wt % to about 13 wt % with respect to a total content (100 wt %) of the resin composition RC. The sub polymer having a weight average molecular weight in a range of about 5000 to about 40000 and derived from the second monomer containing two or more polymerizable unsaturated groups per monomer unit may include at least one selected from UF-C051 (urethane acrylate, manufactured by Kyoeisha Chemical Co., Ltd), UF-C052 (urethane acrylate, manufactured by Kyoeisha Chemical Co., Ltd), UN6304 (urethane acrylate, manufactured by Negami Chemical Industrial Co., Ltd), UV3700B (urethane acrylate, manufactured by Mitsubishi Chemical Corporation), and UV3300B (urethane acrylate, manufactured by Mitsubishi Chemical Corporation).

In the resin composition RC, at least one photoinitiator may include a bisacylphosphine oxide group. For example, the photoinitiator of the resin composition RC may include a radical polymerization initiator. In the resin composition RC, the radical polymerization initiator may be an initiator containing a bisacylphosphine oxide group. In the resin composition RC, the photoinitiator may include a bis(2,4,6-trimethylbenzoyl)phenyl phosphine oxide.

The resin composition RC may include a plurality of photoinitiators. When the resin composition RC includes a plurality of photoinitiators, different photoinitiators may be activated by UV light having different central wavelengths.

In an embodiment, for example, the photoinitiator may further include at least selected from 2,2-dimethoxy-1,2-diphenylethan-1-one, 1-hydroxy-cyclohexyl-phenyl-ketone, 2-hydroxy-2-methyl-1-phenyl-1-propanone, 2-hydroxy-1-[4-(2-hydroxyethoxy)phenyl]-2-methyl-1-propanone, and 2-hydroxy-1-{4-[4-(2-hydroxy-2-methyl-propionyl)-benzyl]-phenyl}-2-methylpropan-1-one.

In addition, the photoinitiator may further include at least one selected from 2-methyl-1[4-(methylthio) phenyl]-2-morpholinopropan-1-one, 2-benzyl-2-dimethylamino-1-(4-morpholinophenyl)-butanone-1, 2-dimethylamino-2-(4-methyl-benzyl)-1-(4-morpholin-4-yl-phenyl)-butan-1-one, 2,4,6-trimethylbenzoyl-diphenylphosphine oxide, ethyl(2,4,6-trimethylbenzoyl)phenyl phosphinate, phenylbis(2,4,6-trimethylbenzoyl)phosphine oxide, [1-(4-phenylsulfanylbenzoyl)heptylideneamino]benzoate, [1-[9-ethyl-6-(2-methylbenzoyl)carbazol-3-yl]ethylideneamino]acetate), and bis(2,4-cyclopentadienyl)bis[2,6-difluoro-3-(1-pyrryl)phenyl]titanium (IV).

In an embodiment, the resin composition RC may include a benzotriazole-based UV absorber. The benzotriazole-based UV absorber contains a benzotriazole group. For example, the benzotriazole-based UV absorber may include 2-(2H-benzotriazol-2-yl)-6-dodecyl-4-methylphenol(2-(2H-benzotriazol-2-yl)-6-dodecyl-4-methylphenol).

In an embodiment where the resin composition RC containing the benzotriazole-based UV absorber has a thickness in a range of about 190 μm to about 210 μm after curing, the resin composition RC may have a transmittance of about 5% or less for light in the wavelength range of about 405 nm or less. In an embodiment where the resin composition RC containing the benzotriazole-based UV absorber has a thickness of about 200 μm after curing, the resin composition RC may have a transmittance of about 5% or less for light in the wavelength range of about 405 nm or less. In an embodiment where the resin composition RC containing the benzotriazole-based UV absorber has a thickness in a range of about 40 μm to about 60 μm after curing, the resin composition RC may have a transmittance of 15% or less for light in the wavelength range of about 405 nm or less. In an embodiment where the resin composition RC containing the benzotriazole-based UV absorber has a thickness of 50 μm after curing, the resin composition RC may have a transmittance of 15% or less for light in the wavelength range of about 405 nm or less. That is, in an embodiment where the adhesive member AP (FIG. 3) formed from the resin composition RC containing the benzotriazole-based UV absorber has a thickness T0 (FIG. 3) of about 190 μm to about 210 μm (e.g., 200 μm), the adhesive member AP may have a transmittance of about 5% or less for light in the wavelength range of about 405 nm or less. In an embodiment where the adhesive member AP (FIG. 3) formed from the resin composition RC containing the benzotriazole-based UV absorber has a thickness T0 (FIG. 3) in a range of about 40 μm to about 60 μm (e.g., 50 μm), the adhesive member AP may have a transmittance of about 15% or less for light in the wavelength range of about 405 nm or less. In an embodiment, the adhesive member AP (FIG. 3) is formed from the resin composition RC containing the benzotriazole-based UV absorber and may thus satisfy the above-described transmittance range.

In an embodiment, a content of the benzotriazole-based UV absorber may be in a range of about 0.5 wt % to about 2 wt % with respect to a total content of the resin composition RC. An adhesive member formed from a resin composition containing the benzotriazole-based UV absorber in a content of less than 0.5 wt % with respect to the total content of the resin composition fails to satisfy the above-described UV transmittance range and exhibits high UV transmittance. The adhesive member having high UV transmittance and a display device including the adhesive member have reduced reliability. A resin composition containing the benzotriazole-based UV absorber in a content of greater than about 2 wt % with respect to the total content of the resin composition is unlikely curable and thus an adhesive member may not be formed. The liquid resin composition RC is cured upon application of UV light to form the adhesive member AP (FIG. 3), and when the weight of the UV absorber is too great (e.g., greater than about 2 wt %), the UV absorber absorbs the UV light provided for curing the resin composition RC, thereby preventing the formation of the adhesive member AP (FIG. 3). In an embodiment, the resin composition RC contains the benzotriazole-based UV absorber in a content of about 0.5 wt % to about 2 wt % with respect to the total content of the resin composition RC such that the resin composition RC may exhibit properties facilitating curing. In addition, the resin composition RC containing the benzotriazole-based UV absorber in the content of about 0.5 wt % to about 2 wt % with respect to the total content of the resin composition RC may form an adhesive member AP that satisfies the above-described transmittance range.

In an embodiment, the resin composition RC may include a diprenyl glycerin ether. In an embodiment where the resin composition RC containing the diprenyl glycerin ether has a thickness in a range of about 190 μm to about 210 μm (e.g., about 200 μm) after curing, the resin composition RC may have a transmittance of about 5% or less for light in the wavelength range of about 405 nm or less. The resin composition RC according to an embodiment may include a diprenyl glycerin ether. In an embodiment where the resin composition RC containing the diprenyl glycerin ether has a thickness of about 40 μm to about 60 μm (e.g., about 50 μm) after curing, the resin composition RC may have a transmittance of about 15% or less for light in the wavelength range of about 405 nm or less. That is, when the adhesive member AP (FIG. 3) formed from the resin composition RC containing the diprenyl glycerin ether has a thickness T0 (FIG. 3) of about 190 μm to about 210 μm (e.g., about 200 μm), the adhesive member AP may have a transmittance of about 5% or less for light in the wavelength range of about 405 nm or less. In an embodiment where the adhesive member AP (FIG. 3) formed from the resin composition RC containing the diprenyl glycerin ether has a thickness T0 (FIG. 3) in a range of about 40 μm to about 60 μm (e.g., about 50 μm), the adhesive member AP may have a transmittance of about 15% or less for light in the wavelength range of about 405 nm or less. The adhesive member AP (FIG. 3) according to an embodiment is formed from the resin composition RC containing the diprenyl glycerin ether and may thus satisfy the above-described transmittance range. In addition, the adhesive member AP (FIG. 3) according to an embodiment is formed from the resin composition RC containing the diprenyl glycerin ether and may thus have small changes in yellow index from exposure to external light, and the like.

In an embodiment, a content of the diprenyl glycerin ether may be in a range of about 0.1 wt % to about 1 wt % with respect to the total content of the resin composition RC. The resin composition containing the diprenyl glycerin ether in a content of less than about 0.1 wt % with respect to the total content of the resin composition does not sufficiently inhibit discoloration and has significant changes in yellow index after curing. That is, an adhesive member formed from the resin composition containing the diprenyl glycerin ether in the content of less than about 0.1 wt % with respect to the total content of the resin composition has greater yellow index values for a longer period of time of exposure to external light such as UV, and degraded display quality. In the resin composition containing the diprenyl glycerin ether in a content of greater than 0.1 wt % with respect to the total content of the resin composition, excess diprenyl glycerin ether is as a plasticizer after curing, resulting in degraded mechanical properties of an adhesive member. In an embodiment, the resin composition RC containing the diprenyl glycerin ether in a content in a range of about 0.1 wt % to about 1 wt % with respect to the total content of the resin composition RC may exhibit properties facilitating curing. In addition, the adhesive member AP (FIG. 3) formed from the resin composition RC containing the diprenyl glycerin ether in a content of about 0.1 wt % to about 1 wt % with respect to the total content of the resin composition RC may have small changes in yellow index from exposure to external light, and exhibit high reliability.

Referring to FIG. 5B, the first light UV-1 may be provided or emitted to the resin composition RC applied at a constant thickness on the substrate CF. The liquid resin composition RC may be cured by the first light UV-1 to form a preliminary adhesive member P-AP (FIG. 5C). The first light UV-1 may be UV light. FIG. 5B shows that the first light UV-1 is directly radiated to the resin composition RC applied on the substrate CF to form the preliminary adhesive member P-AP, but the embodiment of the invention is not limited thereto. A carrier film (not shown) may be disposed on the resin composition RC applied to a uniform thickness, and the carrier film (not shown) may transmit UV light.

Referring to FIGS. 5C and 5D, the preliminary adhesive member P-AP formed by irradiating the resin composition RC with the first light UV-1 (FIG. 5B) may be detached from the substrate CF and provided on one side of the window WP or on one side of the display module DM. One side of the preliminary adhesive member P-AP may be laminated on one side of the window WP or one side of the display module DM, and one side of the window WP or one side of the display module DM that is not attached may be attached to the other side of the preliminary adhesive member P-AP. Thereafter, the second light UV-2 may be radiated to the preliminary adhesive member P-AP to form the adhesive member AP (FIG. 3). The second light UV-2 may be UV light. The second light UV-2 may be provided from an upper portion of the window WP, and the window WP may transmit the second light UV-2. The second light UV-2 may be transmitted through the window WP and provided to the preliminary adhesive member P-AP.

In an embodiment where the resin composition RC has a thickness in a range of about 190 μm to about 210 μm (e.g., about 200 μm) after curing through the light UV-1 and UV-2, the resin composition RC may have a transmittance of about 5% or less for light in the wavelength range of about 405 nm or less. In an embodiment where the resin composition RC has a thickness in a range of about 40 μm to about 60 μm (e.g., about 50 μm) after curing through the light UV-1 and UV-2, the resin composition RC may have a transmittance of about 15% or less for light in the wavelength range of about 405 nm or less. Accordingly, the resin composition RC according to an embodiment may exhibit high UV protection rate after curing.

FIGS. 5A to 5D show that the adhesive member AP (FIG. 3) is formed by curing the resin composition RC twice (i.e., curing by providing light twice), but the embodiment of the invention is not limited thereto. In an embodiment, for example, the adhesive member AP (FIG. 3) may be formed by curing the resin composition RC once, or the adhesive member AP (FIG. 3) may be formed by curing the resin composition RC three or more times.

FIGS. 6A to 6C are views schematically showing a method for manufacturing an adhesive member AP using a resin composition RC according to another embodiment. In the description of an embodiment of a method for manufacturing an adhesive member AP using a resin composition RC with reference to FIGS. 6A to 6C, any repetitive detailed description of the same or like elements as those described above with reference to FIGS. 1 to 5D will be omitted, and differences will be mainly described.

An embodiment of the method for manufacturing an adhesive member AP, as shown in FIGS. 6A to 6C, may include providing a resin composition RC on a display module DM, providing first light UV-1 to the resin composition RC to form a preliminary adhesive member P-AP, and providing second light UV-2 to the preliminary adhesive member P-AP to form an adhesive member AP. The manufacturing method shown in FIGS. 6A to 6C is substantially the same as the manufacturing method shown in FIGS. 5A to 5D except that the resin composition RC is provided on the display module DM.

The resin composition RC may be directly provided on one side of the display module DM or one side of the window WP. FIG. 6A shows that the resin composition RC is directly provided on one surface of the display module DM.

Referring to FIG. 6B, the first light UV-1 may be provided to the uniformly applied resin composition RC. As the first light UV-1 is provided to the resin composition RC, the preliminary adhesive member P-AP may be formed. The window WP may be provided on the preliminary adhesive member P-AP. Referring to FIG. 6C, the second light UV-2 may pass through the window WP and be provided to the preliminary adhesive member P-AP. The preliminary adhesive member P-AP may be cured through the second light UV-2 to form the adhesive member AP (FIG. 3).

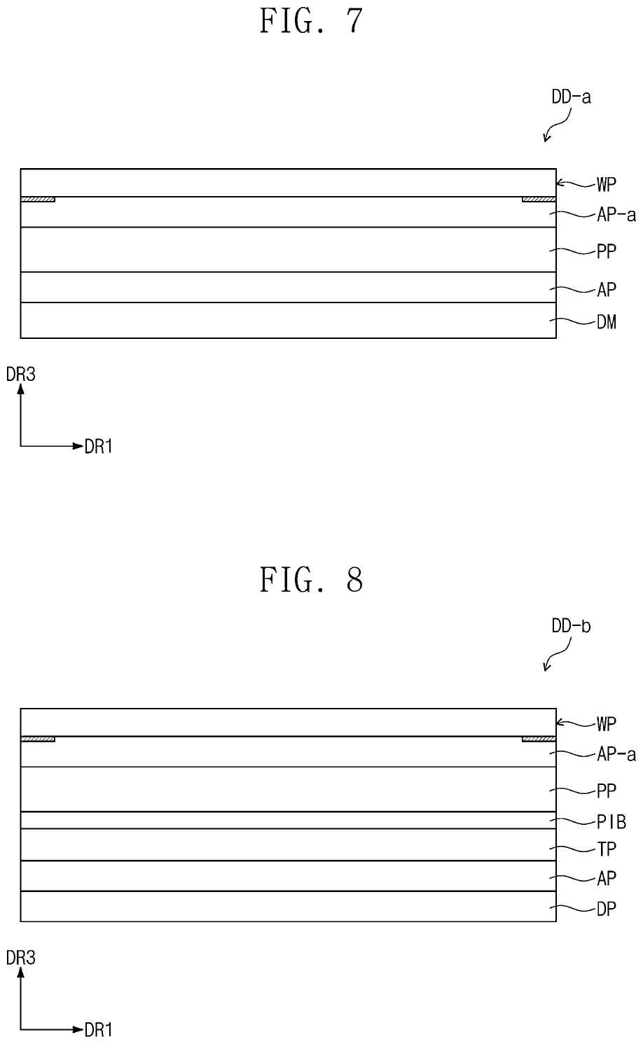

FIG. 7 is a cross-sectional view showing a display device according to another embodiment of the invention. Hereinafter, in the description of the display device according to an embodiment shown in FIG. 7, any repetitive detailed description of the same or like elements as those described above with reference to FIGS. 1 to 6C will be omitted, and differences will be mainly described.

In an embodiment, as shown in FIG. 7, a display device DD-a may further include a light control layer PP and an optical adhesive layer AP-a. The display device DD-a according to an embodiment may further include a light control layer PP disposed between the adhesive member AP and the window WP, and an optical adhesive layer AP-a disposed between the light control layer PP and the window WP. The light control layer PP may include a color filter layer or a polarizing plate.

The optical adhesive layer AP-a may be formed from the resin composition RC according to an embodiment. In such an embodiment, the optical adhesive layer AP-a containing a polymer derived from the resin composition RC has a thickness in a range of about 190 μm to about 210 μm (e.g., about 200 μm), such that the optical adhesive layer AP-a may have a transmittance of about 5% or less for light in the wavelength range of about 405 nm or less. In such an embodiment, the optical adhesive layer AP-a containing a polymer derived from the resin composition RC has a thickness in a range of about 40 μm to about 60 μm (e.g., about 50 μm), such that the optical adhesive layer AP-a may have a transmittance of 15% or less for light in the wavelength range of about 405 nm or less. Accordingly, the display device DD-a including the adhesive member AP may exhibit high reliability.

FIG. 8 is a cross-sectional view showing a display device according to another embodiment of the invention. Hereinafter, in the description of the display device according to an embodiment shown in FIG. 8, any repetitive detailed description of the same or like elements as those described above with reference to FIGS. 1 to 7 will be omitted, and differences will be mainly described.

In an embodiment, as shown in FIG. 8, a display device DD-b may further include a light control layer PP, an optical adhesive layer AP-a, and an interlayer adhesive layer PIB. As the display device DD-a according to an embodiment shown in FIG. 7, the display device DD-b according to an embodiment shown in FIG. 8 may further include the light control layer PP disposed between the adhesive member AP and the window WP, and the optical adhesive layer AP-a disposed between the light control layer PP and the window WP.

In the display device DD-b according to an embodiment, the adhesive member AP may be provided between the display panel DP and the input sensing part TP. That is, the input sensing part TP may not be directly disposed on the display panel DP, and the display panel DP and the input sensing part TP may be bonded through the adhesive member AP. In an embodiment, for example, the adhesive member AP may be disposed between the encapsulation layer TFE (FIG. 3) of the display panel DP and the input sensing part TP.

The interlayer adhesive layer PIB may be provided below the light control layer PP. The interlayer adhesive layer PIB may be disposed between the input sensing part TP and the light control layer PP and may be formed of an adhesive material having high moisture permeation prevention properties. In an embodiment, for example, the interlayer adhesive layer PIB may be formed including polyisobutylene. The interlayer adhesive layer PIB may be disposed on the input sensing part TP to prevent corrosion of sensing electrodes of the input sensing part TP. The display device DD-b according to an embodiment includes the optical adhesive layer AP-a and the adhesive member AP formed from the resin composition RC according to an embodiment, and the display device DD-b including the optical adhesive layer AP-a and the adhesive member AP may exhibit high reliability.

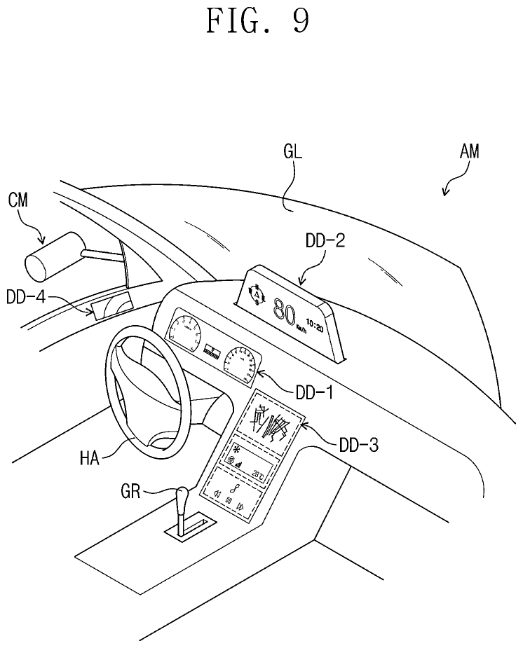

FIG. 9 is a view showing a vehicle AM in which first to fourth display devices DD-1, DD-2, DD-3, and DD-4 are disposed. At least one selected from the first to fourth display devices DD-1, DD-2, DD-3, and DD-4 may have the same components as one of the embodiments of the display device DD, DD-a, and DD-b described above with reference to FIGS. 1 to 3, 7, and 8. At least one selected from the first to fourth display devices DD-1, DD-2, DD-3, and DD-4 may include an embodiment of the adhesive member AP described above with reference to FIGS. 1 to 3, 7, and 8.

FIG. 9 shows a car as the vehicle AM, but this is presented as an example, and the first to fourth display devices DD-1, DD-2, DD-3, and DD-4 may be disposed on other means of transportation, such as bicycles, motorcycles, trains, ships, and airplanes. In addition, at least one selected from the first to fourth display devices DD-1, DD-2, DD-3, and DD-4 including the same components as one of embodiments of the display device DD, DD-a, and DD-b may be adopted for other electronic devices without departing from the teachings therein.

At least one selected from the first to fourth display devices DD-1, DD-2, DD-3, and DD-4 may include an embodiment of the adhesive member AP (FIG. 3) described above. Accordingly, as described above, the adhesive member AP (FIG. 3) in at least one selected from the first to fourth display devices DD-1, DD-2, DD-3, and DD-4 is formed from or using the resin composition RC (FIGS. 5A and 6A), and may thus exhibit high adhesion and high UV protection rate.

Referring to FIG. 9, the vehicle AM may include a wheel HA and a gear GR for operating the vehicle AM, and have a front window GL disposed to face a driver.

The first display device DD-1 may be disposed in a first region overlapping the wheel HA. In an embodiment, for example, the first display device DD-1 may be a digital cluster displaying first information of the vehicle AM. The first information may include a first scale indicating driving speed of the vehicle AM, a second scale indicating engine revolutions (i.e., revolutions per minute (RPM)), and an image indicating fuel gauge, and the like. The first scale and the second scale may be displayed as digital images.

The second display device DD-2 may be disposed in a second region facing a driver seat and overlapping the front window GL. The driver seat may be a seat in which the wheel HA is disposed. In an embodiment, for example, the second display device DD-2 may be a head up display HUD displaying second information of the vehicle AM. The second display device DD-2 may be optically transparent. The second information includes digital numbers indicating driving speed of the vehicle AM and may further include information such as current time. Unlike what is shown, the second information of the second display device DD-2 may be projected and displayed on the front window GL.

The third display device DD-3 may be disposed in a third region adjacent to the gear GR. In an embodiment, for example, the third display device DD-3 may be a center information display CID for a vehicle, which is disposed between a driver seat and a front passenger seat and displays third information. The passenger seat may be a seat spaced apart from the driver seat with the gear GR therebetween. The third information may include information about road conditions (e.g., navigation information), music or radio play, dynamic video (or image) play, temperature inside the vehicle AM, and the like.

The fourth display device DD-4 may be disposed in a fourth region spaced apart from the wheel HA and the gear GR and adjacent to a side of the vehicle AM. In an embodiment, for example, the fourth display device DD-4 may be a digital side mirror displaying fourth information. The fourth display device DD-4 may display images of conditions outside the vehicle AM, which are taken by a camera module CM disposed outside the vehicle AM. The fourth information may include images of conditions outside the vehicle AM.

The first to fourth information described above are presented as an example, and the first to fourth display devices DD-1, DD-2, DD-3, and DD-4 may further display information about inside or outside a vehicle. The first to fourth information may include different information. However, the embodiment of the invention is not limited thereto, and some of the first to fourth information may include the same information.

Hereinafter, with reference to Examples and Comparative Examples, the resin composition according to an embodiment of the invention and the adhesive member formed from the resin composition will be described in greater detail. In addition, Examples below are shown only for the understanding of embodiments of the invention, and the scope of the invention is not limited thereto.

### EXAMPLES

### 1. Preparation of Resin Composition

Resin compositions of Examples and Comparative Examples were prepared using materials listed in Table 1. The materials listed in Table 1 were provided in respective amounts (g, gram) in a lightproof container. Thereafter, the materials were stirred at room temperature and thus uniformly mixed to prepare the resin compositions of Examples and Comparative Examples.

TABLE 1

| | | | | | Comparative | Comparative | Comparative |
|---|---|---|---|---|---|---|---|
| | | Example 1 | Example 2 | Example 3 | Example 1 | Example 2 | Example 3 |
| | | (g) | (g) | (g) | (g) | (g) | (g) |
| Monomer | 2-EHA | 10.95 | 10.95 | | 10.95 | 10.95 | |
| containing | 4-HBA-LT | 1.4 | 1.4 | 2 | 1.4 | 1.4 | |
| one | EHDG-AT | 2.35 | 2.35 | | 2.35 | 2.35 | |
| polymerizable | THF-A | 3 | 3 | 4 | 3 | 3 | 4 |
| unsaturated | IBXA | | | 5.5 | | | 5.5 |
| group | IDAA | | | 6.5 | | | 6.5 |
| Monomer | NDDA | | | 0.1 | | | 0.1 |
| containing | | | | | | | |
| two | | | | | | | |
| polymerizable | | | | | | | |
| unsaturated | | | | | | | |
| groups | | | | | | | |
| Sub Polymer | UF-C051 | 0.6 | 0.6 | | 0.6 | 0.6 | |
| containing | UF-C052 | 0.6 | 0.6 | | 0.6 | 0.6 | |
| two or more | UN6304 | 1.4 | 1.4 | | 1.4 | 1.4 | |
| polymerizable | UV3700B | | | 0.4 | | | 0.4 |
| unsaturated | UV3300B | | | 0.4 | | | 0.4 |
| groups | | | | | | | |
| Benzotriazole- | Tinuvin970 | 0.3 | 0.3 | 0.19 | 0.3 | 0.3 | |
| based UV | | | | | | | |
| absorber | | | | | | | |
| Diprenyl | DPNG | 0.2 | 0.2 | 0.19 | | | |
| glycerin ether | | | | | | | |
| Photoinitiator | Omnirad819 | 0.3 | 0.3 | 0.38 | 0.3 | 0.3 | 0.38 |

### Data on Materials in Table 1

2-EHA: 2-ethylhexyl acrylate (manufactured by Toagosei Co., Ltd.)
4-HBA-LT: 4-hydroxybutyl acrylate (manufactured by Osaka Organic Chemical Industry Ltd)
EHDG-AT: 2-ethylhexyl-diglycol acrylate (manufactured by Kyoeisha Chemical Co., Ltd)
THF-A: Tetrahydrofurfuryl acrylate (manufactured by Kyoeisha Chemical Co., Ltd)
IBXA: Isobornyl acrylate (manufactured by Osaka Organic Chemical Industry Ltd)
IDAA: Isodecyl acrylate (manufactured by Osaka Organic Chemical Industry Ltd)
NDDA: 1,9-Nonanediol diacrylate (manufactured by Osaka Organic Chemical Industry Ltd)
UF-C051: Urethane acrylate (weight average molecular weight: 35000, manufactured by Kyoeisha Chemical Co., Ltd)
UF-C052: Urethane acrylate (weight average molecular weight: 10000, manufactured by Kyoeisha Chemical Co., Ltd)
UN6304: Urethane acrylate (weight average molecular weight: 10000, manufactured by Negami Chemical Industrial Co., Ltd)
UV3700B: Urethane acrylate (weight average molecular weight: 38000, manufactured by Mitsubishi Chemical Corporation)
UV3300B: Urethane acrylate (weight average molecular weight: 13000, manufactured by Mitsubishi Chemical Corporation)
Tinuvin 970: 2H-benzotriazol-2-yl)-6-dodecyl-4-methylphenol (manufactured by BASF corporation)
DPNG: Diprenyl glycerin ether (manufactured by Kuraray Co., Ltd)
Omnirad 819: Bis(2,4,6-trimethylbenzoyl)phenyl phosphine oxide (manufactured by IGM Resin)

In Table 1, the resin compositions of Examples 1 to 3 are resin compositions according to an embodiment. Example 1 and Example 2 are the same resin composition, and the materials and weights of the materials contained in the resin compositions are the same as each other. The resin compositions of Examples 1 to 3 are compositions containing a benzotriazole-based UV absorber and diprenyl glycerin ether. In addition, the resin compositions of Examples 1 to 3 are compositions including a first monomer containing one or two polymerizable unsaturated groups per monomer unit, at least one sub polymer having a weight average molecular weight in a range of about 5,000 to about 40,000 and derived from a second monomer containing two or more polymerizable unsaturated groups per monomer unit, and at least one photoinitiator containing a bisacylphosphine oxide group.

In each of the resin compositions of Examples 1 and 2, 0.3 g of UV absorber is provided with respect to the total weight of 21.1 g of the resin composition, and when converting the weight of the UV absorber by taking 21.1 g to 100 wt %, the weight is found to be about 1.42 wt %. In the resin composition of Example 3, 0.19 g of UV absorber is provided with respect to the total weight of 19.66 g of the resin composition, and when converting the weight of the UV absorber by taking 19.66 g to 100 wt %, the weight is found to be about 0.97 wt %. It is determined that the resin compositions of Examples 1 to 3 satisfy the weight range (i.e., a range of 0.5 wt % to 2 wt %) of the benzotriazole-based UV absorber according to an embodiment.

In each of the resin compositions of Examples 1 and 2, 0.2 g of diprenyl glycerin ether is provided with respect to the total weight of 21.1 g of the resin composition, and when converting the weight of the diprenyl glycerin ether by taking 21.1 g to 100 wt %, the weight is found to be about 0.95 wt %. In the resin composition of Example 3, 0.19 g of diprenyl glycerin ether is provided with respect to the total weight of 19.66 g of the resin composition, and when converting the weight of the diprenyl glycerin ether by taking 19.66 g to 100 wt %, the weight is found to be about 0.97 wt %. It is determined that the resin compositions of Examples 1 to 3 satisfy the weight range (i.e., a range of 0.1 wt % to 1 wt %) of the diprenyl glycerin ether according to an embodiment.

Unlike the resin compositions of Examples 1 and 2, the resin compositions of Comparative Examples 1 and 2 contain no diprenyl glycerin ether. Comparative Examples 1 and 2 are the same resin composition, and the materials and weights of the materials contained in the resin compositions are the same. The only difference between the resin composition of Example 1 and the resin composition of Comparative Example 1 is the inclusion of diprenyl glycerin ether. The only difference between the resin composition of Example 2 and the resin composition of Comparative Example 2 is the inclusion of diprenyl glycerin ether.

Unlike the resin composition of Example 3, the resin composition of Comparative Example 3 contains no diprenyl glycerin ether and benzotriazole-based UV absorber. The resin composition of Comparative Example 3 contains a composition similar to that of the resin composition of Example 3.

### 2. Evaluation of Adhesive Member

Table 2 below shows the results of evaluation on transmittance, CIE color coordinate b* (CIE b*), and yellow index (YI) of adhesive members formed from resin compositions of Examples and Comparative Examples. The adhesive members of Examples 1A to 3A in Table 2 were formed from the resin compositions of Examples 1 to 3 in Table 1, respectively. The adhesive members of Comparative Examples 1B to 3B were formed from the resin compositions of Comparative Examples 1 to 3 in Table 1, respectively.

In Table 2, the initial value of transmittance, initial value of CIE b*, and initial value of YI are values measured before a light resistance test in accordance with a method of MIL-810G. In Table 2, the latter value of transmittance, latter value of CIE b*, and latter value of YI are values measured after a light resistance test in accordance with a method of MIL-810G.

### Transmittance of Adhesive Member

The resin compositions of Examples and Comparative Examples were provided between slide glass S112 manufactured by Matsunami Glass, to which a spacer having a thickness of 50 μm or 200 μm was attached. Thereafter, the resin compositions were irradiated with UV light and cured.

UV-LED lamps having wavelength peaks at 365 nm and 395 nm were used as UV light, and the amounts of light provided were 800 millijoule per square centimeter (mJ/cm²) and 400 mJ/cm², respectively. Then, using a UV-LED lamp having a wavelength peak at 395 nm, UV light was emitted such that the amount of light provided was 4000 mJ/cm² to obtain a sample of an adhesive member formed between the slide glasses. For the adhesive member sample, the transmittance to light of about 405 nm wavelength was measured using a spectrophotometer V770 (UV-Visible & NIR Spectrometer, JASCO Corporation).

In Table 2, Example 1A and Comparative Example 1B used a slide glass attached with a spacer having a thickness of 50 μm. Example 2A, Example 3A, Comparative Example 2B, and Comparative Example 3B used a slide glass attached with a spacer having a thickness of 200 μm. Accordingly, Example 1A and Comparative Example 1B correspond to an adhesive member having a thickness of 50 μm. Example 2A, Example 3A, Comparative Example 2B, and Comparative Example 3B correspond to adhesive members having a thickness of 200 μm. Example 1A and Example 2A are adhesive members formed from the same resin composition, and the only difference is the thickness of the adhesive member. Comparative Example 1B and Comparative Example 2B are adhesive members formed from the same resin composition, and the only difference is the thickness of the adhesive member.

### CIE Color Coordinates b* and Yellow Index of Adhesive Member

CIE color coordinate b* and yellow index were measured for the adhesive member samples obtained from the above-described transmittance measurement. A spectrophotometer COH 7700 (NIPPON DENSHOKU INDUSTRIES Co., Ltd) was used for the measurement.

### Light Resistance Test on Adhesive Member

A light resistance test in accordance with a method of MIL-810G was performed on the adhesive member samples obtained from the above-described transmittance measurement. The light resistance test was performed to determine the resistance of the adhesive members to discoloration and fading upon exposure to UVs, visible light, and the like. The method of MIL-810G is a testing method in accordance with U.S. military standards and was established in 2008.

TABLE 2

| | | | | Comparative | Comparative | Comparative |
|---|---|---|---|---|---|---|
| | Example 1A | Example 2A | Example 3A | Example 1B | Example 2B | Example 3B |
| Thickness of spacer | 50 | 200 | 200 | 50 | 200 | 200 |
| (μm) | | | | | | |
| Initial value of | 4.3 | 0.1 | 1.2 | 14.1 | 0.2 | 1.2 |
| transmittance | | | | | | |
| [405 nm] | | | | | | |
| Latter value of | 8.4 | 0.5 | 3.3 | 17.2 | 0.9 | 3.2 |
| transmittance | | | | | | |
| [405 nm] | | | | | | |
| Initial value of | 8.8 | 13.4 | 11 | 7 | 13.2 | 11 |
| CIE b* | | | | | | |
| Latter value of | 8.8 | 20.7 | 11 | 11.6 | 35 | 15 |
| CIE b* | | | | | | |
| Difference between | 0 | 7.3 | 0 | 4.6 | 21.8 | 4 |
| CIE b* initial value | | | | | | |
| and CIE b* latter | | | | | | |
| value | | | | | | |
| Initial value of YI | 12.8 | 19 | 15.8 | 10.5 | 18.9 | 15.7 |
| Latter value of YI | 12.8 | 31 | 15.8 | 16.9 | 47.8 | 21.6 |
| Difference between | 0 | 12 | 0 | 6.4 | 28.9 | 5.9 |
| YI initial value and | | | | | | |
| YI latter value | | | | | | |

Referring to Table 2, it is shown that the adhesive member of Example 1A having a thickness of 50 μm has a latter value of 15% or less in transmittance. That is, it is shown that the adhesive member of Example 1A has a transmittance of 15% or less to light in the wavelength range of 405 nm after the light resistance test in accordance with a method of MIL-810G. It is shown that the adhesive members of Examples 2A and 3A having a thickness of 200 μm have a latter value of 5% or less in transmittance. That is, it is shown that the adhesive members of Examples 2A and 3A having a thickness of 200 μm have a transmittance of 5% or less to light in the wavelength range of 405 nm after the light resistance test in accordance with a method of MIL-810G.

Referring to Table 2, it is shown that the adhesive members of Examples 1A and 3A have the same initial and latter values for CIE color coordinate b* and yellow index (YI). That is, it is shown that the adhesive members of Examples 1A and 3A shows no change in CIE color coordinate b* and yellow index according to the light resistance test in accordance with a method of MIL-810G. The CIE color coordinate b* and yellow index change depending on the composition of compositions and the thickness of cured products (i.e., adhesive member) formed by curing compositions.

The adhesive members of Examples 1A to 3A are adhesive members formed from the resin compositions of Examples 1 to 3 in Table 1, respectively. As described with reference to Table 1, the resin compositions of Examples 1 to 3 are resin compositions according to an embodiment and include diprenyl glycerin ether and a benzotriazole-based UV absorber. Accordingly, in an embodiment, it is confirmed that the adhesive member formed from the resin composition containing diprenyl glycerin ether and a benzotriazole-based UV absorber is expected to exhibit high reliability even when exposure time to UVs accumulates in usage environment for users.

Referring to Table 2, it is shown that the adhesive member of Comparative Example 1B having a thickness of 50 μm has a latter value of greater than 15% in transmittance. That is, it is shown that the adhesive member of Comparative Example 1B has a transmittance of greater than 15% to light in the wavelength range of 405 nm after the light resistance test in accordance with a method of MIL-810G. In addition, compared to the adhesive member of Example 1A, which has the same thickness, the adhesive member of Comparative Example 1B has a relatively large difference between the initial value and the latter value with respect to CIE color coordinate b* and yellow index (YI). The adhesive member of Comparative Example 1B was formed from the resin composition of Comparative Example 1 in Table 1, and the adhesive member of Example 1A was formed from the resin composition of Example 1 in Table 1. As described above, the only difference between the resin composition of Comparative Example 1 and the resin composition of Example 1 is the inclusion of diprenyl glycerin ether, and the resin composition of Comparative Example 1 contains no diprenyl glycerin ether. Accordingly, it is shown that the adhesive member of Comparative Example 1B had reduced reliability after the light resistance test.

Compared to the adhesive member of Example 2A, which has the same thickness, the adhesive member of Comparative Example 2B has a relatively substantially large difference between the initial value and the latter value with respect to CIE color coordinate b* and yellow index (YI). The adhesive member of Comparative Example 2B was formed from the resin composition of Comparative Example 2 in Table 1, and the adhesive member of Example 2A was formed from the resin composition of Example 2 in Table 1. As described above, the only difference between the resin composition of Comparative Example 2 and the resin composition of Example 2 is the inclusion of diprenyl glycerin ether, and the resin composition of Comparative Example 2 contains no diprenyl glycerin ether. Accordingly, it is shown that the adhesive member of Comparative Example 2B had reduced reliability after the light resistance test.

Compared to the adhesive member of Example 3A, which has the same thickness, the adhesive member of Comparative Example 3B has a relatively large difference between the initial value and the latter value with respect to CIE color coordinate b* and yellow index (YI). The adhesive member of Comparative Example 3B was formed from the resin composition of Comparative Example 3 in Table 1, and the adhesive member of Example 3A was formed from the resin composition of Example 3 in Table 1. As described above, the resin composition of Comparative Example 3 includes composition similar to that of Example 3, but contains no diprenyl glycerin ether and benzotriazole-based UV absorber. Accordingly, it is shown that the adhesive member of Comparative Example 3B had reduced reliability after the light resistance test.

A display device according to an embodiment may include an adhesive member between a display panel and a window. The adhesive member according to an embodiment may be formed from or using a resin composition. The resin composition according to an embodiment may include a benzotriazole-based UV absorber and diprenyl glycerin ether. Accordingly, the resin composition according to an embodiment may exhibit properties facilitating curing. The adhesive member formed from or using the resin composition according to an embodiment may exhibit high UV protection rate. The adhesive member and the display device including the adhesive member may exhibit high reliability.

A resin composition according to an embodiment includes a diprenyl glycerin ether and a benzotriazole-based UV absorber and may thus exhibit high reliability after curing.

An adhesive member according to an embodiment includes a polymer derived from the resin composition, and may thus exhibit high reliability.

A display device according to an embodiment includes the adhesive member, and may thus exhibit high reliability.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A resin composition comprising:
at least one first monomer containing one or two polymerizable unsaturated groups per monomer unit;
at least one sub polymer having a weight average molecular weight in a range of about 5,000 to about 40,000 and derived from a second monomer containing two or more polymerizable unsaturated groups per monomer unit;
a benzotriazole-based UV absorber;
a diprenyl glycerin ether; and
at least one photoinitiator containing a bisacylphosphine oxide group.

2. The resin composition of claim 1, wherein after photocuring, the resin composition has a thickness in a range of about 190 μm to about 210 μm, and
the resin composition has a transmittance of greater than about 0% and less than or equal to about 5% for light in a wavelength range of about 405 nm or less.

3. The resin composition of claim 1, wherein after photocuring, the resin composition has a thickness in a range of about 40 μm to about 60 μm, and
the resin composition has a transmittance of greater than about 0% and less than or equal to about 15% for light in a wavelength range of about 405 nm or less.

4. The resin composition of claim 1, wherein a content of the benzotriazole-based UV absorber is in a range of about 0.5 wt % to about 2 wt % with respect to a total content of the resin composition.

5. The resin composition of claim 1, wherein a content of the diprenyl glycerin ether is in a range of about 0.1 wt % to about 1 wt % with respect to a total content of the resin composition.

6. The resin composition of claim 1, wherein the first monomer comprises a (meth)acrylate monomer.

7. The resin composition of claim 1, wherein the first monomer comprises a first sub-monomer containing one polymerizable unsaturated group per monomer unit and a second sub-monomer containing two polymerizable unsaturated groups per monomer unit.

8. The resin composition of claim 1, wherein the first monomer comprises at least one selected from 2-ethylhexyl acrylate (2-EHA), 4-hydroxybutyl acrylate (4-HBA-LT), 2-ethylhexyl-diglycol acrylate (EHDG-AT), tetrahydrofurfuryl acrylate (THF-A), isobornyl acrylate (IBXA), isodecyl acrylate (IDAA), and 1,9-nonanediol diacrylate (NDDA).

9. The resin composition of claim 1, wherein the sub polymer comprises a urethane (meth)acrylate oligomer.

10. The resin composition of claim 1, wherein the photoinitiator comprises bis(2,4,6-trimethylbenzoyl)phenyl phosphine oxide.

11. The resin composition of claim 1, wherein the resin composition is providable through inkjet printing or dispensing.

12. An adhesive member comprising a polymer derived from a resin composition,
wherein the resin composition includes:
at least one first monomer containing one or two polymerizable unsaturated groups per monomer unit;
at least one sub polymer having a weight average molecular weight in a range of about 5,000 to about 40,000 and derived from a second monomer containing two or more polymerizable unsaturated groups per monomer unit;
a benzotriazole-based UV absorber;
a diprenyl glycerin ether; and
at least one photoinitiator containing a bisacylphosphine oxide group.

13. The adhesive member of claim 12, wherein the adhesive member has a thickness in a range of about 190 μm to about 210 μm, and
the adhesive member has a transmittance of greater than about 0% and less than or equal to about 5% for light in a wavelength range of about 405 nm or less.

14. The adhesive member of claim 12, wherein the adhesive member has a thickness in a range of about 40 μm to about 60 μm, and
the adhesive member has a transmittance of greater than about 0% and less than or equal to about 15% for light in a wavelength range of about 405 nm or less.

15. The adhesive member of claim 12, wherein the adhesive member has a thickness in a range of about 30 μm to about 300 μm.

16. The adhesive member of claim 12, wherein a content of the benzotriazole-based UV absorber is in a range of about 0.5 wt % to about 2 wt % with respect to a total content of the resin composition.

17. The adhesive member of claim 12, wherein a content of the diprenyl glycerin ether is in a range of about 0.1 wt % to about 1 wt % with respect to a total content of the resin composition.

18. The adhesive member of claim 12, wherein the first monomer comprises a first sub-monomer containing one polymerizable unsaturated group per monomer unit and a second sub-monomer containing two polymerizable unsaturated groups per monomer unit.

19. The adhesive member of claim 12, wherein the first monomer comprises at least one selected from 2-ethylhexyl acrylate (2-EHA), 4-hydroxybutyl acrylate (4-HBA-LT), 2-ethylhexyl-diglycol acrylate (EHDG-AT), tetrahydrofurfuryl acrylate (THF-A), isobornyl acrylate (IBXA), isodecyl acrylate (IDAA), and 1,9-nonanediol diacrylate (NDDA).

20. The adhesive member of claim 12, wherein the sub polymer comprises a urethane (meth)acrylate oligomer.

21. The adhesive member of claim 12, wherein the photoinitiator comprises bis(2,4,6-trimethylbenzoyl)phenyl phosphine oxide.

22. A display device comprising:
a display panel;
a window disposed on the display panel; and
an adhesive member disposed between the display panel and the window and including a polymer derived from a resin composition,
wherein the resin composition includes:
at least one first monomer containing one or two polymerizable unsaturated groups per monomer unit;
at least one sub polymer having a weight average molecular weight in a range of about 5,000 to about 40,000 and derived from a second monomer containing two or more polymerizable unsaturated groups per monomer unit;
a benzotriazole-based UV absorber;
a diprenyl glycerin ether; and
at least one photoinitiator containing a bisacylphosphine oxide group.

23. The display device of claim 22, wherein the adhesive member has a thickness in a range of about 190 μm to about 210 μm, and
the adhesive member has a transmittance of greater than about 0% and less than or equal to about 5% for light in a wavelength range of about 405 nm or less.

24. The display device of claim 22, wherein when the adhesive member has a thickness of about 40 μm to about 60 μm, the adhesive member has a transmittance of greater than about 0% and less than or equal to about 15% for light in a wavelength range of about 405 nm or less.

25. The display device of claim 22, wherein the adhesive member has a thickness in a range of about 30 μm to about 300 μm.

26. The display device of claim 22, wherein
a content of the benzotriazole-based UV absorber is in a range of about 0.5 wt % to about 2 wt % with respect to a total content of the resin composition, and
a content of the diprenyl glycerin ether is in a range of about 0.1 wt % to about 1 wt % with respect to the total content of the resin composition.

27. The display device of claim 22, wherein the first monomer comprises a first sub-monomer containing one polymerizable unsaturated group per monomer unit and a second sub-monomer containing two polymerizable unsaturated groups per monomer unit.

28. The display device of claim 22, wherein the first monomer comprises at least one selected from 2-ethylhexyl acrylate (2-EHA), 4-hydroxybutyl acrylate (4-HBA-LT), 2-ethylhexyl-diglycol acrylate (EHDG-AT), tetrahydrofurfuryl acrylate (THF-A), isobornyl acrylate (IBXA), isodecyl acrylate (IDAA), and 1,9-nonanediol diacrylate (NDDA).

29. The display device of claim 22, wherein the sub polymer comprises a urethane (meth)acrylate oligomer.

30. The display device of claim 22, wherein the photoinitiator comprises bis(2,4,6-trimethylbenzoyl)phenyl phosphine oxide.

31. The display device of claim 22, further comprising a light control layer disposed between the adhesive member and the window, and an optical adhesive layer disposed between the light control layer and the window,
wherein the optical adhesive layer includes a polymer derived from the resin composition.

32. The display device of claim 22, further comprising an input sensing part disposed between the display panel and the window,
wherein the adhesive member is disposed between the display panel and the input sensing part or between the input sensing part and the window.
